(19) United States
(12) Patent Application Publication
(10) Pub. No.: US 2023/0075994 A1
(43) Pub. Date: Mar. 9, 2023

(54) AUTOMATIC HOME COOKING MACHINE

(71) Applicant: PROFUTECH LTD., Holon (IL)

(72) Inventors: Ariel WEINTRAUB, Holon (IL); Tal BEN MENASHE, Holon (IL)

(21) Appl. No.: 17/913,462

(22) PCT Filed: Mar. 25, 2021
(86) PCT No.: PCT/IL2021/050338

§ 371 Date: Sep. 22, 2022

(30) Foreign Application Priority Data
Mar. 29, 2020 (IL) 273675

(51) Int. Cl. A47J 27/12; A47J 44/00; H05B 6/12

(52) U.S. Cl. CPC A47J 27/12; A47J 44/00; H05B 6/1272

(57) ABSTRACT

An automatic home cooking machine comprises a food storage section for dry and unperishable food products, means for controllably discharging food products from the food storage section, a dispensing section which includes a plurality of spaced controllable food dispensers retained within a stationary freezer compartment, a lower plate on which are positionable a plurality of food vessels, a rotatable insulating plate located below the freezer compartment and formed with an aperture through which desired food products are gravitationally delivered either from the food storage section or from the dispensing section to an underlying one of the food vessels located directly below the aperture, and cooking apparatus adapted to cook the food products received within each of the food vessels.

### FIELD OF THE INVENTION

The present invention relates to the field of kitchen automation. More particularly, the invention relates to a compact home cooking machine for automatically cooking and serving personalized food portions.

### BACKGROUND OF THE INVENTION

Many handicapped or elderly people lack sufficient manual dexterity to prepare food items by themselves. These people cannot live independently and have to rely on family members, friends or paid employees for assistance, or alternatively have to be institutionalized.

A home cooking machine for automatically cooking and serving personalized food portions at a predetermined time would help the handicapped and elderly to remain living independently. Such a home cooking machine would also assist children whose parents are not home, or do not have time to cook, to receive cooked meals while their parents can decide what they will eat. A home cooking machine would also be beneficial to people who do not have knowledge or experience in cooking, or do not have time to cook.

Many vending machines are known to supply cooked food items; however these machines are excessively costly and bulky for use as a home appliance, and additionally lack the programming and communication capabilities to serve personalized food portions at a predetermined time.

It is an object of the present invention to provide an automatic home cooking machine for cooking and serving personalized food portions at a predetermined time.

It is an additional object of the present invention to provide an automatic home cooking machine that is sufficiently compact to be deployed at an above-counter or built-in space, yet is able to hold a large number of ready to prepare food portions in long-time frozen storage.

Other objects and advantages of the invention will become apparent as the description proceeds.

### SUMMARY OF THE INVENTION

An automatic home cooking machine comprises a food storage section for dry and unperishable food products, means for controllably discharging food products from said food storage section, a dispensing section which includes a plurality of spaced controllable food dispensers retained within a stationary freezer compartment, a lower plate on which are positionable a plurality of food vessels, a rotatable insulating plate located below said freezer compartment and formed with an aperture through which desired food products are gravitationally delivered either from said food storage section or from said dispensing section to an underlying one of the food vessels located directly below said aperture, and cooking apparatus adapted to cook the food products received within each of the food vessels.

In one embodiment, each of the plurality of food dispensers is configured with a bottomless storage section within which one or more perishable food products are storable, a rigid lid positioned on top of said storage section, and a rotatably mounted shaft connected to a center of the lid which, when rotated, causes the lid to rotate and the one or more perishable food products to gravitate from said storage section. The freezer compartment is configured with a bottom wall that is formed with a plurality of apertures within each of which the storage section of a corresponding food dispenser is frictionally fitted.

In one aspect, the food storage section is configured with a plurality of separate and elongated compartments within each of which a different unperishable food product is storable, and the means for controllably discharging food products from the food storage section comprises a screw conveyor rotatably mounted in each of said plurality of compartments to facilitate conveyance and discharge of a predetermined amount of a selected food product, a trough for receiving the discharged unperishable food product, and a chute extending downwardly and at an incline from the trough.

In one aspect, side walls of the freezer compartment are configured with an undercut arrangement to ensure that the rotatable insulating plate will be in insulating proximity to the bottom wall of the freezer compartment and that a portion of the insulating plate will be positioned externally to the freezer compartment, so as to be accessible to an exit opening of the chute.

In one embodiment, the cooking machine further comprising a controller which is operable to—

i. rotate the insulating plate to a first position, prior to rotation of the shaft to cause gravitational dispensing of the one or more perishable food products from a selected food dispenser to the underlying food vessel, such that the aperture of the insulating plate is aligned with the aperture of the freezer compartment with which the selected food dispenser is frictionally fitted and other apertures of the freezer compartment are occluded by the insulating plate; and

ii. rotate the insulating plate to a second position, prior to operation of one of the screw conveyors to cause gravitational delivery of a selected unperishable food product via the chute to the underlying food vessel, such that the aperture of the insulating plate is aligned with the exit opening of the chute while the other apertures of the freezer compartment are occluded by the insulating plate.

In one embodiment, the cooking machine further comprises a feeding section laterally spaced to the freezer compartment through which an used food vessel is introducible, and vertical transfer apparatus configured with a vertically oriented endless belt aligned with an interspace between said feeding section and a cooking machine casing and with one or more support clips attached to said endless belt for intercepting a food vessel introduced through said feeding section, wherein said vertical transfer apparatus is adapted to downwardly transfer said intercepted food vessel to a waiting position above a cooking machine floor.

In one aspect, the lower plate is configured with a circular base plate, a plurality of pivotable leaf elements each of which provided with a solid recessed region to support a corresponding food vessel, and a dividing element, wherein of each said leaf elements is outwardly pivotable with respect to said base plate during rotation in a first rotational direction of the lower plate and is seatable in a corresponding recessed portion defined by said base plate and two adjacent arms of said dividing element when set to a non-pivoted position during rotation in a second rotational direction of the lower plate which is opposite to the first rotational direction.

In one aspect, rotation of the lower plate is synchronized with operation of the vertical transfer apparatus, such that one of the leaf elements is pivoted into a zone of the feeding section to receive the food vessel held at the waiting position during release of the support clip from the food vessel held at the waiting position.

A food vessel for facilitating both cooking of food products received therewithin and holding the food products after being cooked and while being eaten comprises a lower receptacle having an upper opening, and an upper cover member covering the upper opening, wherein an outer layer of the receptacle is made of ceramic material and an inner layer thereof is made of a food-safe ferromagnetic material that becomes sufficiently heated to cook the received food products when impinged upon by a magnetic flux field generated by one or more induction heating units, and wherein the outer ceramic layer is able to become sufficiently cooled within less than one minute, when the food vessel is out of range of the magnetic flux field, so that the food vessel is able to be safely held by a user wishing to eat the cooked food products while continuing to be retained within the receptacle.

In one aspect, the cover member is loosely receivable on top of the receptacle, and has an upwardly projecting annular throat which is provided with an inwardly disposed annular abutment that defines a central socket adapted to receive and interface with an extendable and rotatable drive shaft configured with two spring-loaded latches.

In one aspect, the abutment is configured to urge radially inward compression of the two latches during downward displacement of the drive shaft that causes contact with the abutment, and to provide secured engagement with the two latches after being extended following additional downward displacement of the drive shaft, and wherein the cover member is removable from the receptacle following upward displacement of the drive shaft while the two latches are in secured engagement with the abutment.

In one aspect, the cover member is further comprised with an interface member configured with the abutment and with a cooking worthy implement, the interface member being vertically and rotatably displaceable with respect to the throat during selective manipulation of the drive shaft.

### BRIEF DESCRIPTION OF THE DRAWINGS

In the drawings:

FIG. 1A is a perspective view from the front and left side of an automatic cooking machine while its door is opened and its food storage section is detached from the cooking machine casing, showing cooking machine apparatus arranged in four distinct levels;

FIG. 1B is a perspective view from the front of the cooking machine of FIG. 1A, shown when most of its apparatus has been removed;

FIG. 1C is a perspective view from the top and right side of the cooking machine of FIG. 1A, shown without its casing;

FIG. 1D is a perspective view from the top and left side of the cooking machine of FIG. 1A, shown without its casing;

FIG. 1E is a front view of the cooking machine of FIG. 1A, shown without its casing;

FIG. 1F is a left side view of the cooking machine of FIG. 1A, shown without its casing;

FIG. 1G is a rear view of the cooking machine of FIG. 1A, shown without its casing;

FIG. 1H is a right side view of the cooking machine of FIG. 1A, shown without its casing;

FIG. 2 is a front view of a door used in conjunction with the cooking machine of FIG. 1A;

FIG. 3 is a rear view of the door of FIG. 2;

FIG. 4A is a top view from above of a rotatable insulating plate used in conjunction with the cooking machine of FIG. 1A;

FIG. 4B is a perspective view from above of the insulating plate of FIG. 4A;

FIG. 5A is a perspective right and top view of a freezer compartment used in conjunction with the cooking machine of FIG. 1A;

FIG. 5B is a horizontal cross sectional view of the freezer compartment of FIG. 5A;

FIG. 6 is a perspective view of apparatus by which each of a plurality of food dispensers used in conjunction with the cooking machine of FIG. 1A is rotatably mounted onto an arcuate plate;

FIG. 7 is an exploded view of one of the food dispensers of FIG. 6;

FIG. 8 is an exploded view of another one of the food dispensers of FIG. 6;

FIG. 9 is a perspective view from above of a food discharging assembly used in conjunction with the cooking machine of FIG. 1A, showing its upper food storage section in exploded view;

FIG. 10 is a perspective view from above of the food discharging assembly of FIG. 9, when its upper food storage section is assembled;

FIG. 11 is a perspective view from above of the food storage section of FIG. 10, shown with a cover which is pivotally opened;

FIG. 12A is a perspective view from the top, front and left side of the cooking machine of FIG. 1A, showing a sub-divided spice holding chamber, while the cooking machine casing is removed and the food storage section is detached from the cooking machine;

FIG. 12B is a perspective view from the top and right side of the cooking machine of FIG. 12A, shown without its casing and feeding section;

FIG. 13A is a vertical cross sectional view of the spice holding chamber of FIG. 12A, showing a plurality of its sub-compartments;

FIG. 13B is a cross sectional view cut along plane A-A of FIG. 13k showing a selector gear for selectively transferring torque to the shaft of one of the sub-compartments;

FIG. 14 is a perspective view of a holding plate used in conjunction with the cooking machine of FIG. 1A, showing each leaf element thereof in an unpivoted position;

FIG. 15 is an exploded view of the holding plate of FIG. 14;

FIG. 16 is a perspective view of a food vessel used in conjunction with the cooking machine of FIG. 1A;

FIG. 17 is a perspective, vertical cross sectional view cut through the food vessel of FIG. 16, showing its interface member in a lowered position;

FIG. 18 is a perspective, vertical cross sectional view cut through the food vessel of FIG. 16, showing its interface member in a raised position;

FIG. 19A is an exploded view of the food vessel of FIG. 16;

FIG. 19B is a perspective view of the food vessel of FIG. 16, showing rotation preventing means when the cover member and receptacle are separated one from the other;

FIGS. 20A-H are a cross sectional view cut through a drive shaft and food vessel used in conjunction with the cooking machine of FIG. 1A, showing eight different positions of the drive shaft relative to the food vessel, respectively;

FIG. 21A is an exploded view of vertical transfer apparatus used in conjunction with the cooking machine of FIG. 1A;

FIG. 21B of the vertical transfer apparatus of FIG. 21B, showing two food vessels held thereby;

FIG. 21C is a vertical cross section view of the apparatus of FIG. 21B;

FIG. 21D is a perspective view from the right side of the vertical transfer apparatus of FIG. 21A and of support elements on which the vertical transfer apparatus is mounted;

FIG. 22 is a perspective view of an oil reservoir used in conjunction with the cooking machine of FIG. 1A;

FIG. 23 is a perspective view of a control valve used in conjunction with the cooking machine of FIG. 1A;

FIG. 24 is a block diagram of a control system used in conjunction with the cooking machine of FIG. 1A; and

FIG. 25 is a flow chart illustrating various control system operations involved in cooking and serving personalized food portions with the cooking machine of FIG. 1A.

### DETAILED DESCRIPTION OF THE INVENTION

The automatic home cooking machine is beneficial to those who are incapable of cooking, or do not have time to cook. For example, the home cooking machine is designed for providing a sufficient supply of cooked meals, such as at least a week's supply, for a person who is isolated in one's house for a similar period of time and is unable to purchase food and to also prepare and cook food items due to physical impairments. The tasty cooked food items are made ready to eat at a predetermined time and are available at an access port of the cooking machine, from which they are easily and comfortably removed by the user prior to the meal.

To facilitate home use, the cooking machine is of compact configuration by which its outer casing, preferably rectilinear, is sufficiently small to accommodate an above-counter or built-in space, for example having outer dimensions of 55 cm×45 cm×55 cm. Despite such small dimensions, the cooking machine is equipped with at least one freezer compartment in which at least a week's supply of food is stored, food transfer equipment, food heating apparatus and control circuitry to support both local control and remote programming of food preparations. Accordingly, the cooking machine is adapted to transfer a food portion from a freezer compartment to a cooking station without compromising the quality of the frozen foods due to an influx of heat to the freezer compartment and without disrupting the performance of the cooking element due to an influx of cold air thereto.

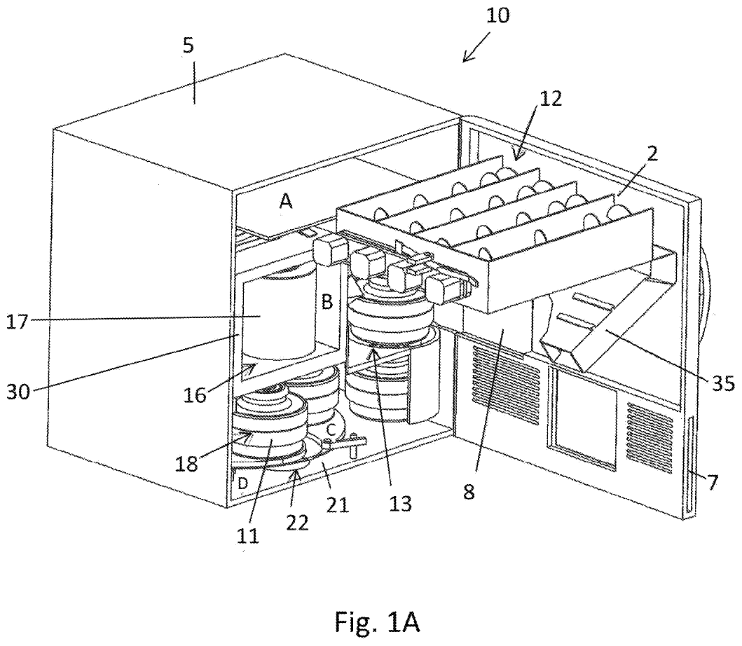

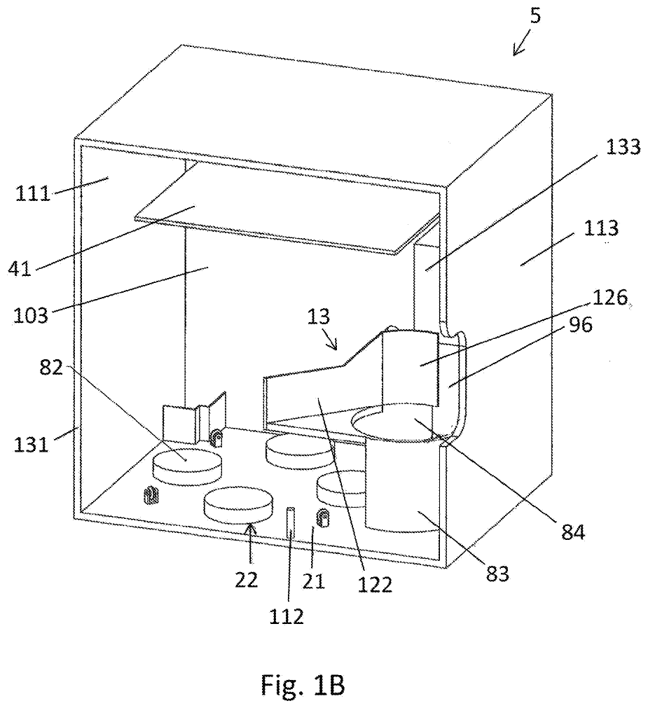

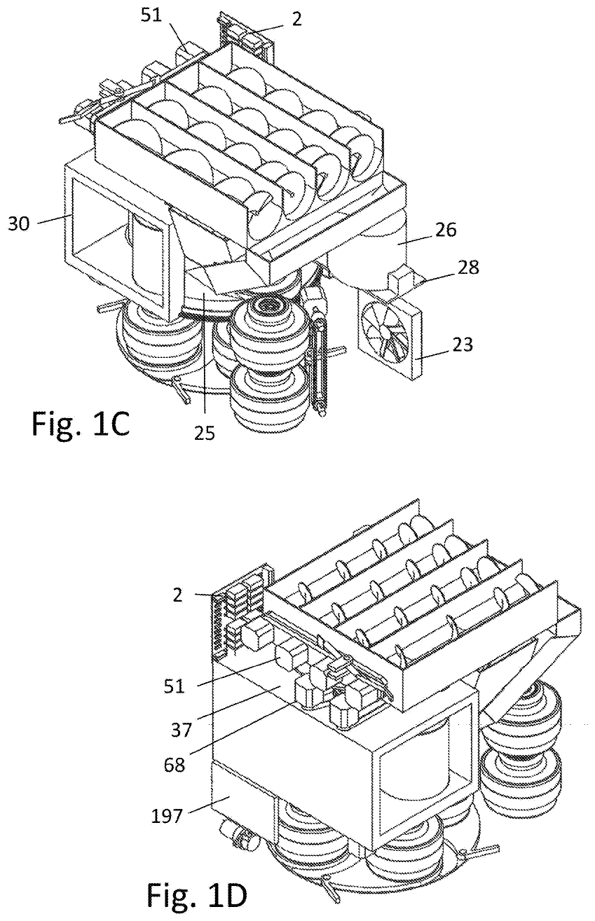

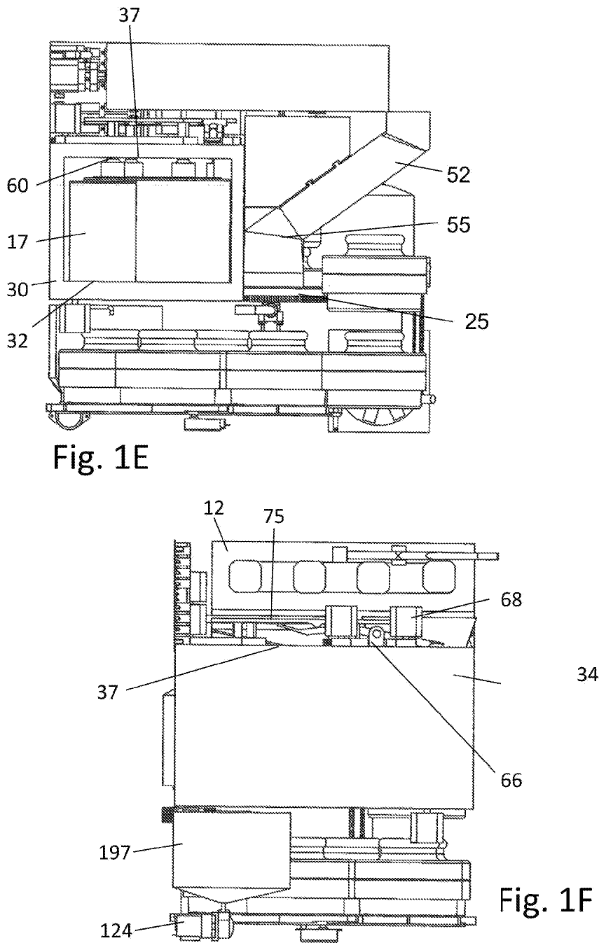

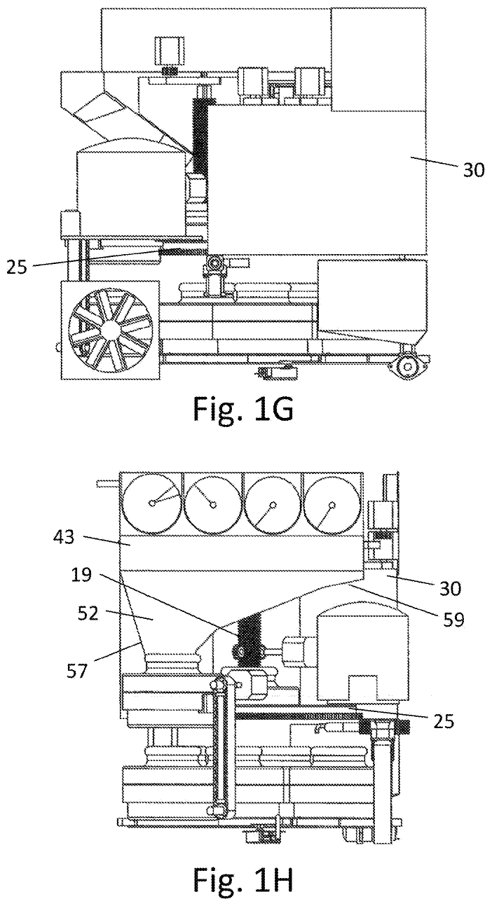

FIG. 1A illustrates the general arrangement of cooking machine 10, according to one embodiment, shown when door 2 is opened.

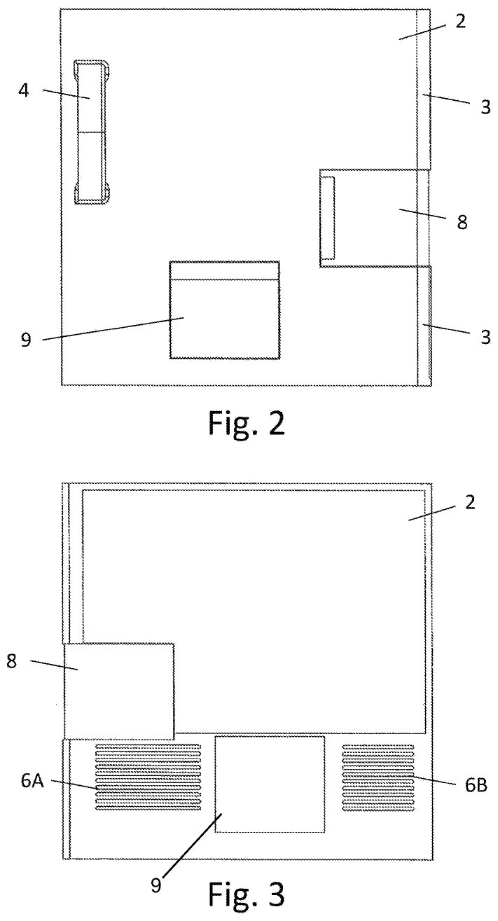

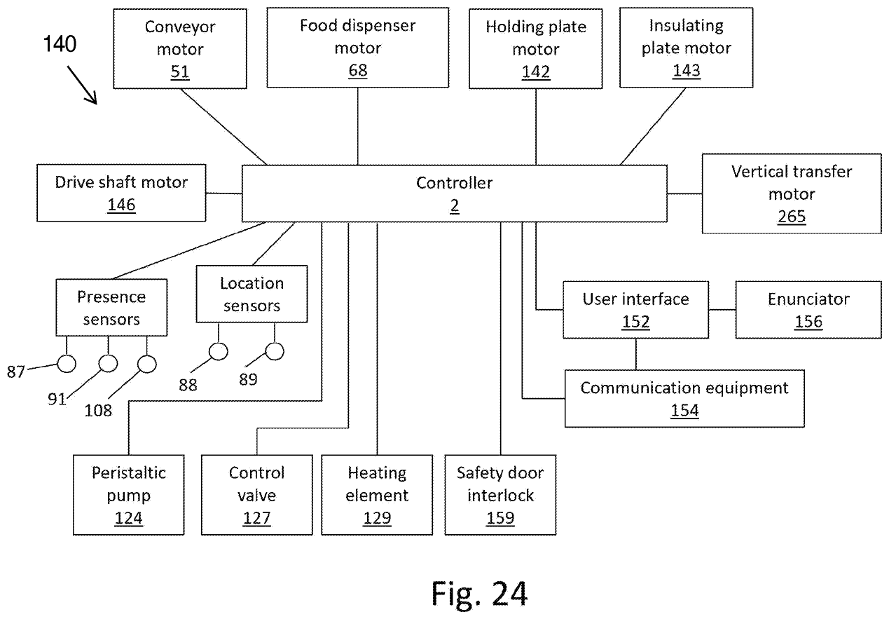

FIG. 2 illustrates a front view of door 2 of the cooking machine, which is pivotally openable by means of handle 4 in order to access the food storage section as well as food dispensers. Although not shown, a touch screen configured with dedicated input elements may be accessibly housed in door 2. An opening 8, which may be fitted with a laterally openable and closable closure, through which a clean and unused food vessel is introducible, is positioned between the two vertically spaced hinges 3 of door 2. As will be explained, the novel food vessel is used for both cooking a personalized food portion and for eating the cooked food. Another opening 9, from which a food vessel containing the ready to eat cooked food is removable and which may also be fitted with a laterally openable and closable closure, is centrally located within door 2 but at a level lower than that of closure 8. Opening 9 is preferably fitted with a safety door interlock 159 (FIG. 24).

FIG. 3 illustrates a rear view of door 2. Door 2 is shown to be configured with two regions 6A-B of airflow openings at each side of opening 9. Alternatively, only one region may be provided. Inflow of air into the cooking machine interior flows through opening 7 formed in the side of door 2 (FIG. 1A) and through the airflow openings of regions 6A-B which are in fluid communication of opening 9. Heat generated by the cooking machine is dissipated by the flow of heated air through the cooking machine interior, which is subsequently discharged by fan-condenser unit 23 (FIG. 1C). The heated air is advantageously discharged through the side of door 2 so as not to be annoyingly discharged onto the face of a user accessing the home cooking machine, for example to remove a food vessel containing ready to eat cooked food or to load an unused food vessel.

Referring back to FIG. 1A, the apparatus of cooking machine 10 is shown to be positioned in four distinct levels A-D in order to compactly utilize the small height of its casing. Food storage section 12 with a lower narrowing discharging section 35 for dry and unperishable food products is deployed at the uppermost level A. The second level B located below section 12 provides a feeding section 13 into which an empty and unused food vessel 11 is introducible via opening 8, as well as dispensing section 16, which includes a plurality of spaced food dispensers 17 retained within a freezer compartment 30, and also an extendable and rotatable drive shaft adapted to be coupled with a food vessel. Transfer section 18 that includes a plurality of food vessels 11 for receiving food products from the discharging section 35 of unperishable food storage section 12 or from dispensing section 16, as well as vessel transfer equipment, is located within third level C below dispensing section 16. Cooking apparatus 22 located within lower level D and located above cooking machine floor 21 is adapted to cook the food products received within the food vessels 11. These four levels are enclosed by casing 5, which is generally rectilinear.

Casing 5 may be configured with the following three layers for superior insulation, reduced weight and good durability: an outer aluminum layer, an intermediate insulation layer of moisture resistant rock wool, and an inner aluminum layer. It will be appreciated that other types of insulation or layers may be used as well.

To illustrate that various support elements of cooking machine 10 are detachable, for example by means of dedicated sliding elements which are lockable when not detached, in order to enable the cleaning of various surfaces, food storage section 12 is shown in FIG. 1A to be detached from casing 5. FIG. 18 illustrates various elements that are fixedly attached to casing 5. A support surface 41 for supporting food storage section 12 (FIG. 1A), which may be cantilevered, extends inwardly from casing rear wall 103. Support surface 41 may not laterally extend throughout the width of casing rear wall 103 to accommodate the positioning of controller 2 and motors 51 and 68, shown in FIGS. 1C-D, within the space between support surface 41 and casing left wall 111 and above freezer compartment 30 (FIG. 1A). The stator of motors 51 and 68 is generally, but not necessarily, attached to casing left wall 111. Controller 2, which comprises control circuitry and commands operation of motors 51 and 68, is programmable, and may also be manually settable.

A plurality of induction heating units 82 project upwardly from cooking machine floor 21. An upwardly extending tubular sleeve 83 for directing an introduced unused food vessel towards cooking machine floor 21, which may be of semicircular cross section, is attached to a forward portion of casing right wall 113. Vertical guide elements 122 and 126 guide the introduced food vessel towards upper inlet port 84 of sleeve 83. Rearwardly from arcuate guide element 126 is positioned refrigeration equipment housing 133.

### Freezer Compartment Retained Dispensing Section

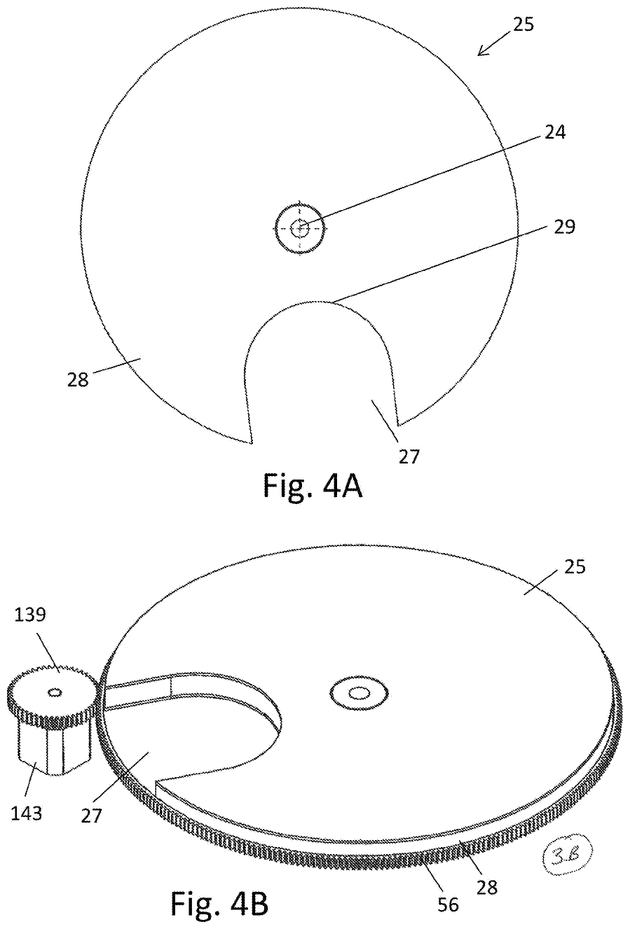

The compact layout of the cooking machine is made possible by virtue of rotatable insulating plate 25, e.g. circular, which separates dispensing section 16 from transfer section 18 (FIG. 1A). Insulating plate 25, as more clearly shown in FIGS. 4A-B, is formed with a through-hole aperture 27 through which desired food products are gravitationally delivered from food storage section 12 or from dispensing section 16 to a food vessel U positioned within transfer section 18. Insulating plate 25 is controllably rotated by a motor 143 such as a step motor, so that aperture 27 will be able to be aligned with one of the food dispensers 17, which is commanded to dispense a desired food product. Aperture 27 may be semielliptical such that an extension of its centerline coincides with the center 24 of the circular plate 25 while its vertex 29 is radially spaced from the center, and may be cutout from plate periphery 28.

Insulating plate 25 may be configured with a coaxial gear wheel 56 attached to, and located therebelow, such that the outer gear elements of gear wheel 56 are of the same outer diameter as, and coincident with, plate periphery 28. The outer gear elements of gear wheel 56 are intermeshed with gear 139 connected to the output shaft of motor 143; causing insulating plate 25 to rotate about its center 24 upon operation of motor 143.

Insulating plate 25 may be supported while rotating by means of a bearing, which is connected to the freezer compartment, such as by a rod, or by means of any other support technique well known to those skilled in the art.

As shown in FIG. 1E, insulating plate 25 is disposed below stationary bottom wall 32 of freezer compartment 30, and serves to maintain sub-freezing temperatures within the freezer compartment so that the storage time of the perishable meat products provided within each food dispenser 17 will be maximized even while insulating plate 25 is being rotated.

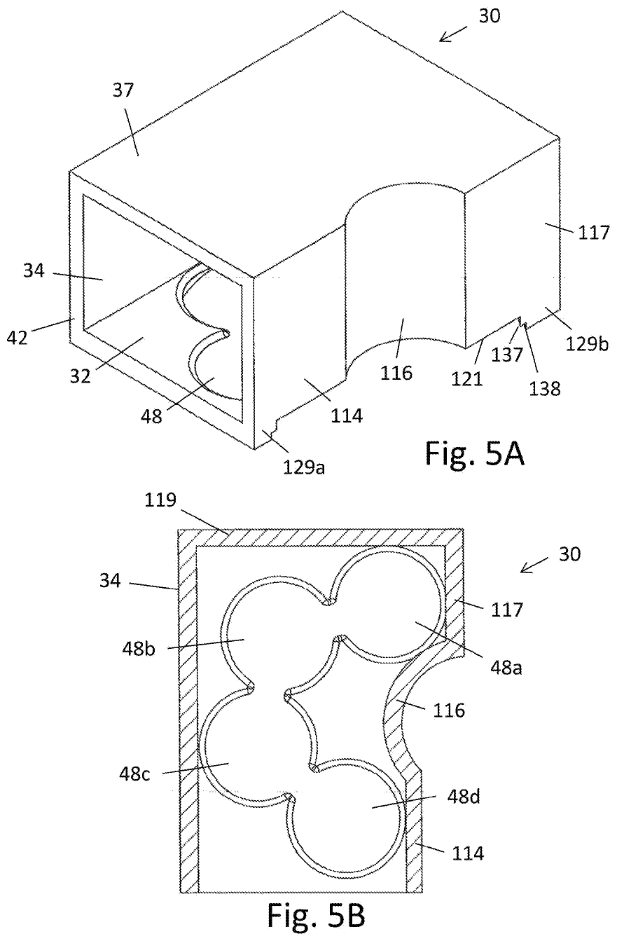

With reference also to FIG. 5A-B, stationary bottom wall 32 of freezer compartment 30 is formed with a plurality of apertures 48, for example apertures 48a-d, within each of which a corresponding food dispenser is frictionally fitted. Despite the presence of these apertures 48, the sub-freezing temperatures within the freezer compartment are able to be advantageously maintained by virtue of insulating plate 25, which occludes all of the apertures 48, with the exception of the single aperture 48 which is intended to be aligned with the semielliptical aperture 27 of the insulating plate.

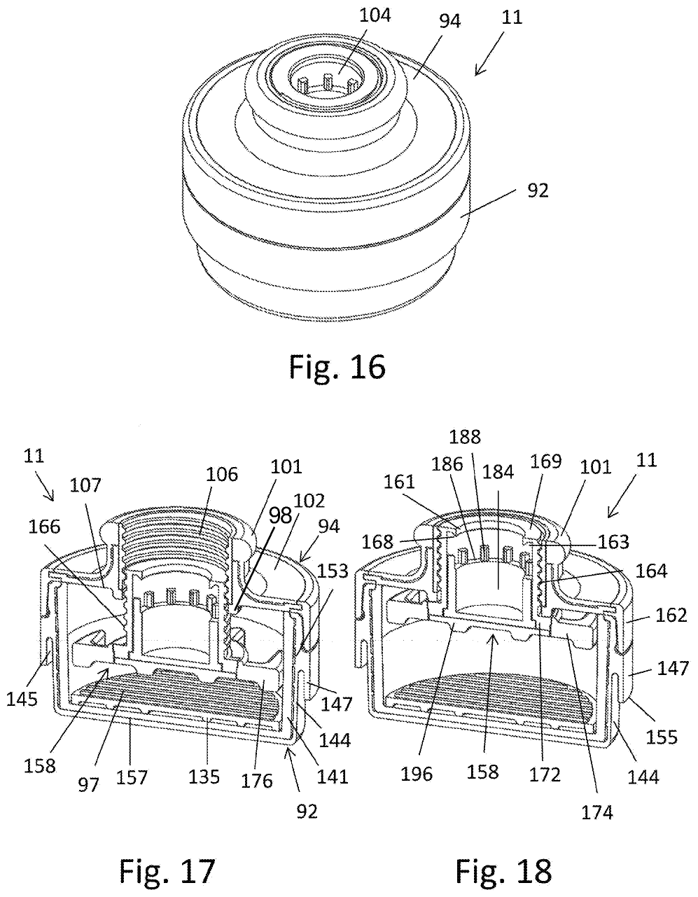

Freezer compartment 30 generally has a rectilinear configuration to accommodate the rectilinear configuration of the cooking machine casing, and its walls, including bottom wall 32, side walls 34, 114 and 117, arcuate wall 116 extending between spaced side walls 114 and 117, rear wall 119, and upper wall 37 have a thickness of at least approximately 30 mm. Side wall 34 is permanently mounted on casing left wall 111 (FIG. 1B), and rear wall 119 is permanently mounted on casing rear wall 103. The front face 42 of freezer compartment 30 may be flush with the front face 131 of casing 5, or positioned slightly rearwardly therefrom. Side walls 114 and 117 are located at an opposite side of freezer compartment 30 than side wall 34, and arcuate wall 116 defines an open space for the raising and lowering therethrough of a food vessel cover member 94 (FIG. 16) after being separated from the corresponding receptacle 92, as will be described hereinafter. The food products that are discharged from discharging section 35 (FIG. 1A) flow close to side wall 114 while gravitating towards an underlying uncovered food vessel located within transfer section 18 (FIG. 1A).

In order to ensure that insulating plate 25 will suitably insulate freezer compartment 30 and occlude all of the apertures 48, side walls 114 and 117 and arcuate wall 116 may be formed with an undercut which is arranged such that their common bottom edge 121, which is aligned with the upper face of bottom wall 32, is located above spaced bottom extremities 129a and 129b. Each of bottom extremities 129a and 129h is formed with two differently dimensioned undercut edges 137 and 138 to accommodate the different radial dimension of the periphery of insulating plate 25 and of gear wheel 56 (FIG. 4B), respectively, while rotating. By the undercut arrangement, the rotating insulating plate 25 is able to be in abutting relation with bottom wall 32, or alternatively the spacing therebetween is minimized, to maximize the insulating capabilities of insulating plate 25. Both the insulating plate and the freezer compartment walls may be made of three separate aluminum surfaces, between each pair an insulation filler layer is introduced, or alternatively other insulation arrangements may be provided.

The undercut arrangement also facilitates the provision of a portion of insulating plate 25 that is positioned externally to freezer compartment 30, so as to be accessible to lower discharging section 35 of the food discharging assembly, as shown in FIGS. 1C, 1E, 1G, and 1H. Thus food products may be gravitationally delivered from discharging section 35 through the aperture 27 of insulating plate 25 (FIG. 4A) that is instantaneously disposed below discharging section 35. If some of the small-sized food products that are gravitationally delivered from discharging section 35 have excessive kinetic energy and impinge side wall 114 of freezer compartment 30 (FIG. 5B), they are deflected by side wall 114 and are urged into aperture 27.

The sub-freezing temperatures within the freezer compartment are made possible by means of compressor 26, which is housed in refrigeration equipment housing 133 (FIG. 1B) and mounted on a support surface 28 (FIG. 1C) externally to side wall 117, for compressing a circulating refrigerant, e.g. a quarter horsepower compressor, fan-condenser unit 23 mounted on floor 21 and proximate to casing side wall 113 (FIG. 1B) for condensing the compressed refrigerant gas and expelling the generated heat externally from casing 5, an expansion valve (not shown) for lowering the pressure of high-pressure liquid, and an evaporator unit (not shown) located within freezer compartment 30 by which heat greater than the sub-freezing temperatures is absorbed by the refrigerant, which is caused to be gasified.

As shown in FIG. 1E, an adapter 60 connected to a corresponding food dispenser 17 and having a shaft extension that passes through an aperture formed in upper freezer compartment wall 37 facilitates rotation of the food dispenser.

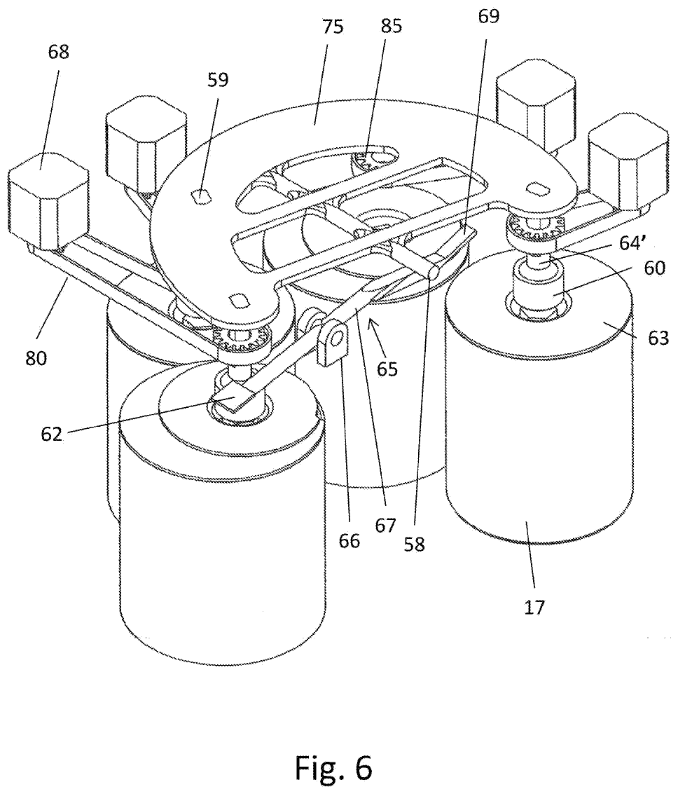

As shown in FIG. 6, each of the shaft extensions 64′ is rotatably mounted to plate 75, which is positioned below the underside of food storage section 12, as shown in FIG. 1F. Plate 75 may be arcuate in order to avoid interference with the food dispenser motors 68. Each food dispenser motor 68, which is mounted onto the casing left wall 111 (FIG. 18), is in force transmitting relation with a corresponding shaft extension 64′, for example by means of an endless belt wrapped around a gear 85 which is mounted on shaft extension 64′. Adapter 60, which has a larger diameter than, and is integrally formed with, or connected to, shaft extension 64′, is frictionally connected to a corresponding food dispenser shaft.

FIG. 6 illustrates four circumferentially separated food dispensers 17, and it will be appreciated that any other number of food dispensers may be employed and that any suitable type of perishable food may be dispensed thereby. For example, one food dispenser is adapted to store a plurality of spaced and vertically oriented hot dogs, whether made from meat products or non-meat products. Other food dispensers may store chicken breasts, hamburgers, or meatballs.

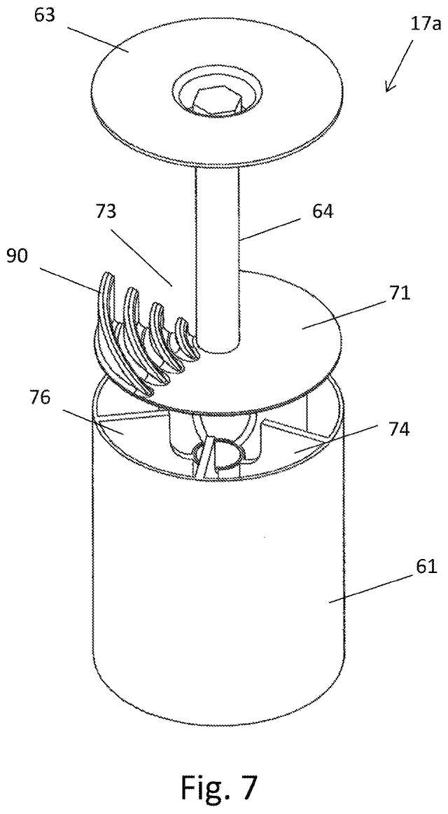

Each of the food dispensers may be configured with a bottomless cylindrical storage section 51 (FIG. 7), e.g. made of food-safe polypropylene or polyethylene with a non-stick coating. A rigid lid 63 is positioned on top of storage section 61, and a shaft 64 connected to the shaft extension at its upper end vertically extends downwardly into the interior of storage section 61 through the center of lid 63.

Each food dispenser 17 is replaceable, for example in order to be cleaned, or is replenishable when separated from plate 75 by means of decoupling member 65. Decoupling member 65 has an elongated shank 67 that is pivotally connected to a pair of vertical eyelets 66 connected to, and protruding upwardly from, upper wall 37 of the freezer compartment, as shown in FIG. 1F. Shank 67 terminates at one end with a planar manipulator 62 and at the other end with one or more inclined elements 69. When manipulator 62 is pressed downwardly, shank 67 pivots and a terminal element 69 rises and forcefully contacts a protrusion 58 that protrudes horizontally from the periphery of plate 75, causing at least a region of plate 75 to be lifted. While the plate region is lifted, adapter 60 becomes separated from the corresponding shaft 64, and is similarly lifted relative to the frictionally fixed food dispenser 17. The food dispenser may then be removed from the aperture in which it is frictionally fitted, in order to be cleaned, filled or replaced.

Alternatively or in addition, the supply of meat products, or of other protein rich products stored within the limited volume of the container, may be replenished via a door formed in the wall of the storage section that is pivotally openable, generally manually.

All of the food dispensers may be maintained at the same temperature by the freezer equipment, or alternatively each food dispenser may be maintained at an individualized temperature that is suitable to maximize freshness of the corresponding food product.

Food dispenser 17a shown in FIG. 7 has a bottom plate 71, generally circular, located below storage section 61 to which is connected shaft 64. A portion of plate 71 such as a sector thereof is formed with a void area 73, such as a cutout region. The storage section 61 of food dispenser 17a is stationary, and may be subdivided by a plurality of radially extending dividers 74 into separated chambers 76, into each of which a specific number of vertically oriented food items, e.g. hot dogs, supported by plate 71 are storable. When shaft 64 is caused to rotate, plate 71 is also caused to rotate, so that the food items in the chamber 76 no longer supported by plate 71 overlie void area 73 and are gravitationally discharged therethrough, via aperture 27 of insulating plate 25 (FIG. 4A), into an underlying food vessel. Aperture 27 of insulating plate 25 is sized to surround food dispenser 17a, as well as every other food dispenser, when aligned therewith following controlled displacement of insulating plate 25. Thus hot dogs are assured of being gravitationally discharged through aperture 27 regardless of the angular orientation of plate 71. A plurality of discharging elements 90, for example radially separated and arcuate blades which may have a progressively increased height radially outwardly, protrude upwardly from bottom plate 71, preferably adjacent to void area 73, in order to urge frozen food items which may be encased by ice to be discharged into void area 73. The food dispenser motor associated with food dispenser 17a is activated only if the aperture of the insulating plate is aligned with void area 73.

A food dispenser in which meatballs are storable may be configured similarly as food dispenser 17a, such that a plurality of meatballs positioned one on top of the other may be positioned in each chamber 76.

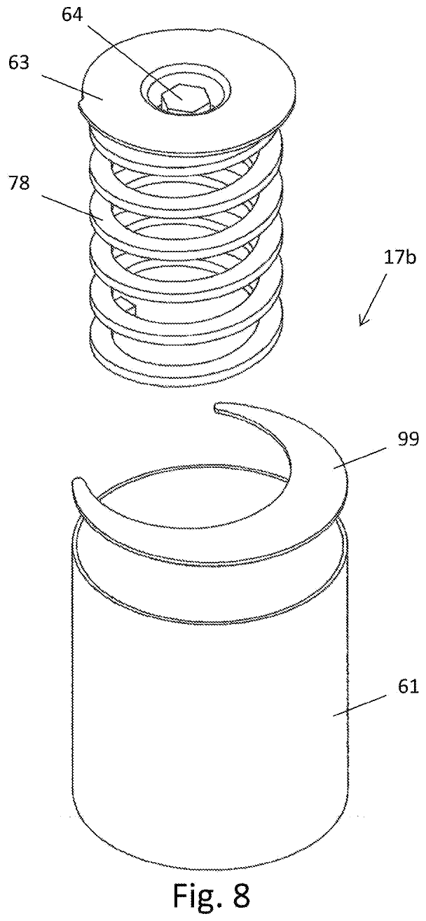

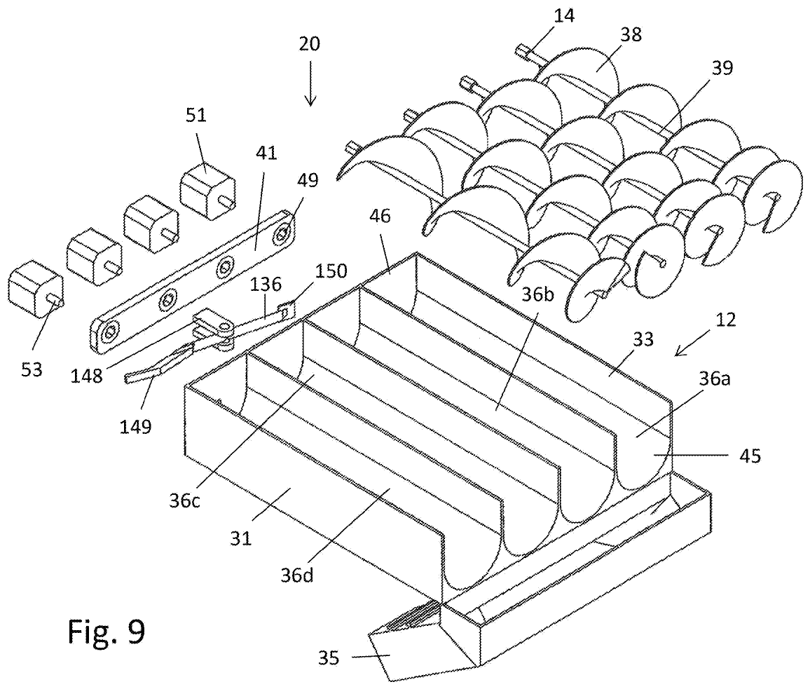

FIG. 8 illustrates food dispenser 17b, which is adapted to store chicken breasts. A chicken breast is inserted between two adjacent turns of an annular and vertically disposed screw conveyor 78, which extends downwardly from lid 63. When shaft 64 is caused to rotate, the helical turns of screw conveyor 78 force the chicken breast downwardly via the aperture of the insulating plate, into an underlying food vessel. The food dispenser motor associated with food dispenser 17b is activated only if the aperture of the insulating plate is aligned with food dispenser 17b.

An arcuate plate 99 for movably supporting screw conveyor 78 may be connected to the bottom of storage section 61. As the outer periphery of screw conveyor 78 has a diameter that is less than that of storage section 61 but greater than that of arcuate plate 99, the dispensed frozen chicken breasts will be advantageously prevented from adhering to the wall of storage section 61.

A food dispenser in which hamburgers are storable may be configured similarly as food dispenser 17b.

### Food Discharging Assembly for Unperishable Foods

Reference is now made to FIGS. 1A, 1C-H and 9-11, which illustrate the structure of food discharging assembly 20 comprising upper food storage section 12 and lower discharging section 35.

Food storage section 12, which may be rectilinear, is delimited by front wall region 31, rear wall region 33, and side wall region 46. Food storage section 12 is configured with four, or any other desired number, of separate compartments, e.g. compartments 36a-d, into each of which a different unperishable food product is storable. The discharging opening 45 of each compartment is provided without a side wall to facilitate flow of a food product to discharging section 35 without interference. A cover 15 of food storage section 12 is pivotally openable to expose each of the compartments, so that desired small-sized food products may be introduced, preferably at one end of the corresponding compartment. Exemplary small-sized food products that can be stored in food storage section 12 include carbohydrates such as rice, grains and pasta products and vegetables such as carrots, peas and beans.

Each of the compartments 36a-d of food storage section 12 is elongated and is equipped with a corresponding screw conveyor 38 having a shaft 39 that ends with a male fitting 14. Each male fitting 14 passes through a corresponding aperture formed in side wall region 46 and is frictionally engaged with the drive shaft 53 of a corresponding conveyor motor 51, to facilitate transfer of torque to the corresponding screw conveyor shaft 39. Drive shaft 53 of a corresponding conveyor motor 51 in turn passes through an aligned aperture 49 of an elongated guide element 41.

In order to be cleaned, for example, food storage section 12 is easily decoupled from the conveyor motors 51, which are mounted on the casing left wall 111, by means of decoupling member 136. Decoupling member 136 is pivotally displaceable about a vertical axis with use of support unit 148, which is mounted to the cooking machine casing. Following manipulation of angled handle 149, a planar terminal element 150 at an end of decoupling member 136 forcefully contacts a side wall region 46, causing lateral displacement of food storage section 12 away from the conveyor motors 51 and release of each male fitting 14 from the corresponding drive shaft 53.

The length between the two extreme flights of screw conveyor 38 is less than that of the corresponding compartment, allowing the screw conveyor to advance within the corresponding compartment and to thereby convey the food product to a corresponding discharge opening 45 that is formed proximate to casing wall 113 (FIG. 1B). A conveyor motor 51 may be activated for a controlled duration by the control circuitry, whether wirelessly or by a wired connection, so that a predetermined amount of the selected food product will be conveyed and discharged.

To provide assembly 20 with a food discharging capability, discharging section 35 is employed. Discharging section 35 comprises trough 43 and a chute 52 extending downwardly and at an incline from trough 43. Trough 43 has a wall 44 that is continuous with the inter-compartment walls 54 formed at the discharge openings 45. An intermediate inclined wall 47 extends downwardly from wall 44 to chute 52.

The conveyed food products are discharged via a discharge opening 45 of one of the compartments to one or more internal inclined surfaces 47 provided within discharging section 35, and are consequently gravitationally transferred to chute 52. Chute 52 has a non-uniform cross section arranged such that its front inclined edge 57 has a significantly larger angle with respect to a horizontal plane than its rear inclined edge 59, as shown in FIG. 1H. Consequently, the small-sized food products that are gravitationally delivered through chute 52 are transferred to an exit opening 55 located at a forward portion of the cooking machine that is proximate to side wall 114 of freezer compartment 30 and approximately 10 cm above insulating plate 25, as shown in FIG. 1E, and then to an open food vessel located below the exit opening 55 when aperture 27 of insulating plate 25 is aligned with the exit opening.

A weight sensor may be mounted on chute 52, or on any other suitable element of discharging section 35, in order to maintain an inventory of stored food items within food storage section 12 and to detect the quantity of small-sized food products that have been discharged therefrom.

A weight sensor may likewise be mounted on the bottom plate of a food dispenser, for example bottom plate 71 of food dispenser 17a, or coinciding with each chamber 76 thereof, in order to maintain an inventory of stored food items and to detect when a food item is discharged from the food dispenser.

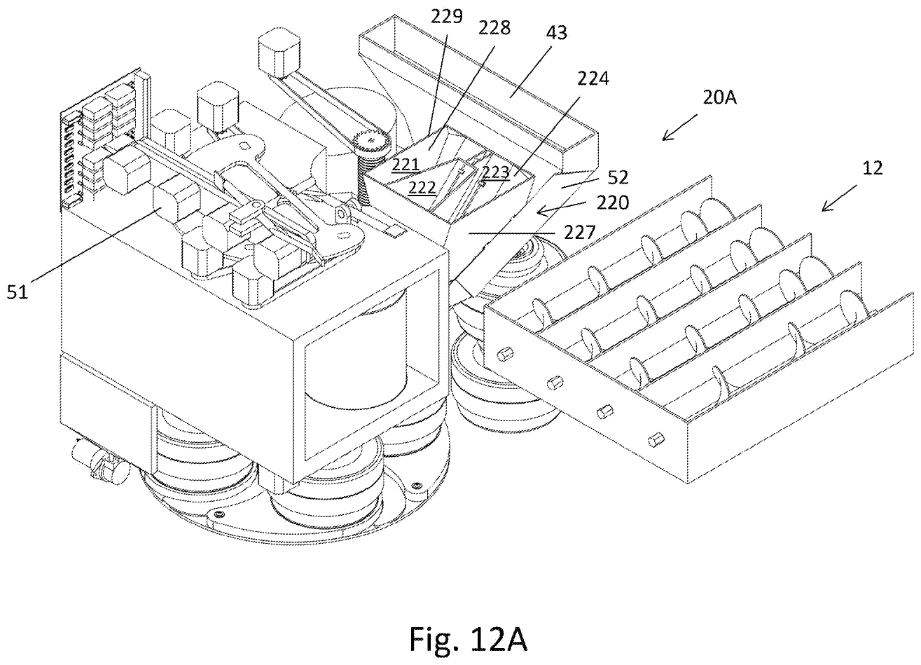

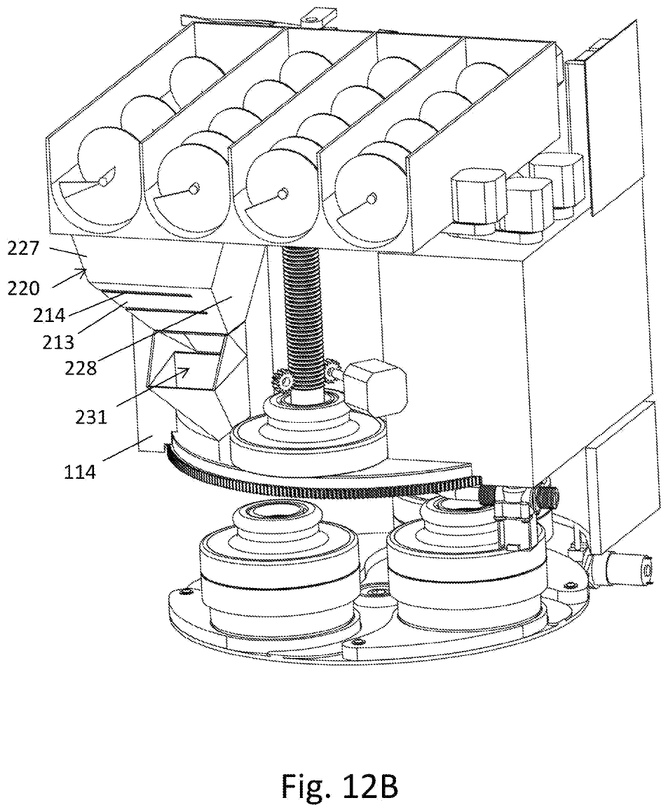

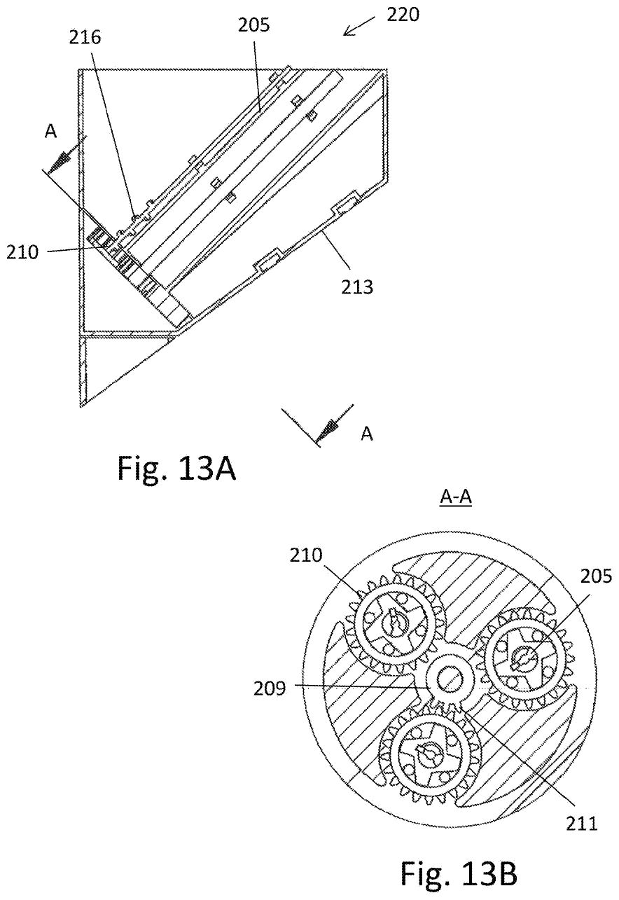

In one embodiment, as shown in FIGS. 12A-B and 13A-8, food discharging assembly 20A comprises a sub-divided spice holding chamber 220, in addition to food storage section 12, trough 43 and chute 52.

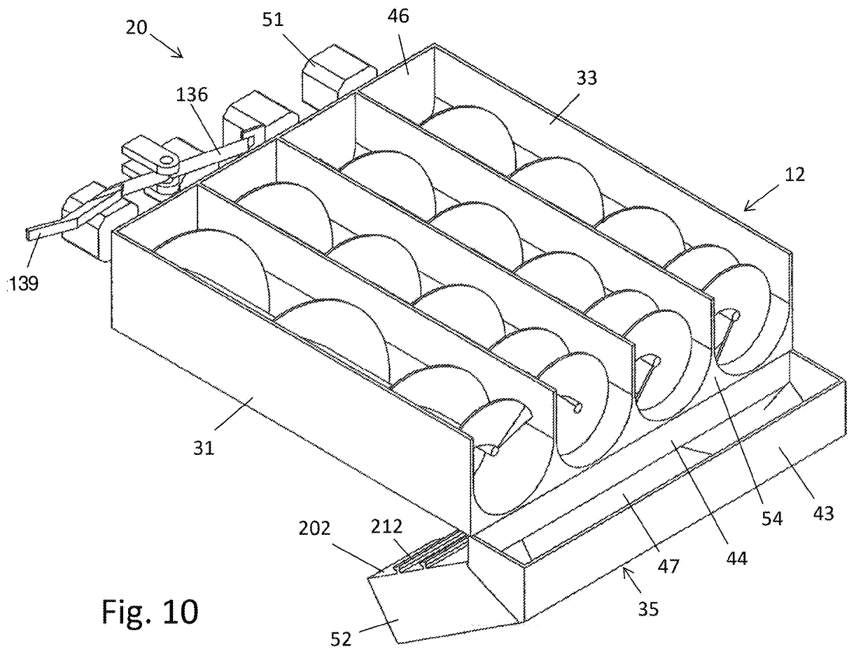

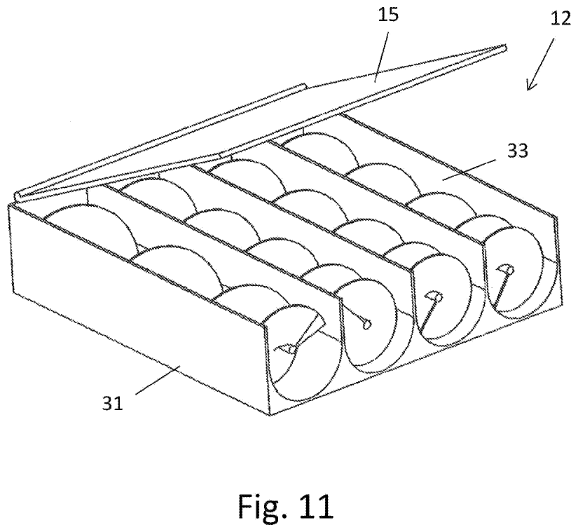

Spice holding chamber 220 is positioned in the void space between wall 114 of the freezer compartment and chute 52, and has polygonal front and rear side walls 227 and 228 each having at least one oblique edge to accommodate the arrangement of the void space. The spices are top-loaded through the upper edge 229 of spice holding chamber 220, which lacks an upper wall and is rectangular such as square. Food storage section 12 is normally supported by upper edge 229, and is adapted to be in abutting relation with trough 43 as shown in FIG. 10 when coupled with motors 51.

Spice holding chamber 220 has an inclined trailing wall 213 that is configured with a plurality of spaced linear recesses 214, with each of which a corresponding linear protrusion 212 protruding from an inclined leading wall 202 of chute 52 (FIG. 10) is adapted to be releasably coupled.

Spice holding chamber 220 is subdivided into a plurality of small sub-compartments, e.g. the three illustrated sub-compartments 221-223. Each sub-compartment, which is adapted to receive for example a different spice, is configured with an internal inclined wall 224 to facilitate gravitational delivery of the corresponding spice to an exit opening 231 located above the insulating plate aperture.

Each sub-compartment is configured with its own shaft 205 and its own screw conveyor 216 to initiate delivery of the corresponding spice stored therein. A gear 210 is provided at the end of the corresponding shaft 205. Operation of one motor may advantageously cause any one of a selected shaft 205 to rotate by means of a selector gear 209. Selector gear 209 has gear teeth 211 only at a specific sector arranged to be engaged with only one of the gears 205. Upon controlled rotation of selector gear 209, teeth 211 will be engaged with a different gear 205.

In one embodiment, a directing member is used to direct food products discharged from exit opening 55 of chute 52 (FIG. 1E) or exit opening 231 of spice holding chamber 220 to the insulating plate aperture. The directing member shown in FIG. 128 is connected to spice holding chamber 220, and has an upper wall formed with an aperture that is aligned with exit opening 231. The leading inclined wall of the directing member is closed, to define an obtuse angle relative to the leading inclined wall of spice holding chamber 220. The directing member also has a trailing opening that is in communication with the chute exit opening. A bottom inclined wall of the directing member defining an acute angle relative to its leading wall receives the discharged food products and enables them to be gravitationally delivered to the insulating plate aperture.

### Cooking and Transfer Apparatus

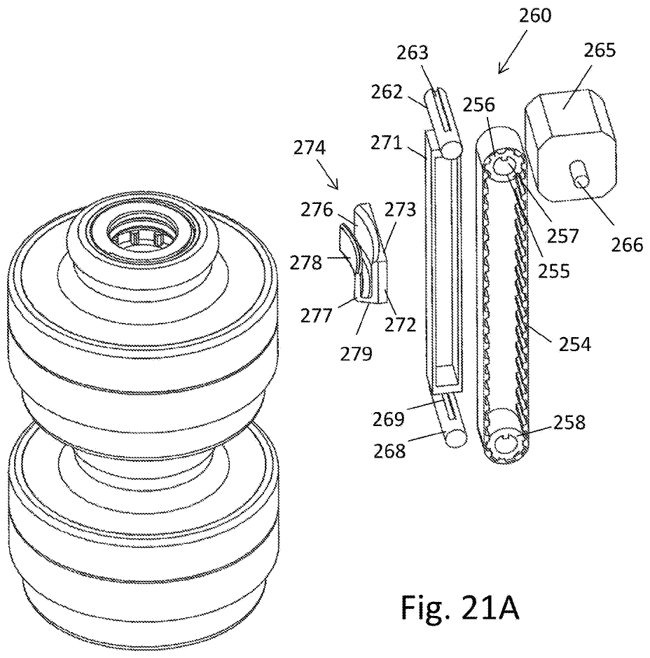

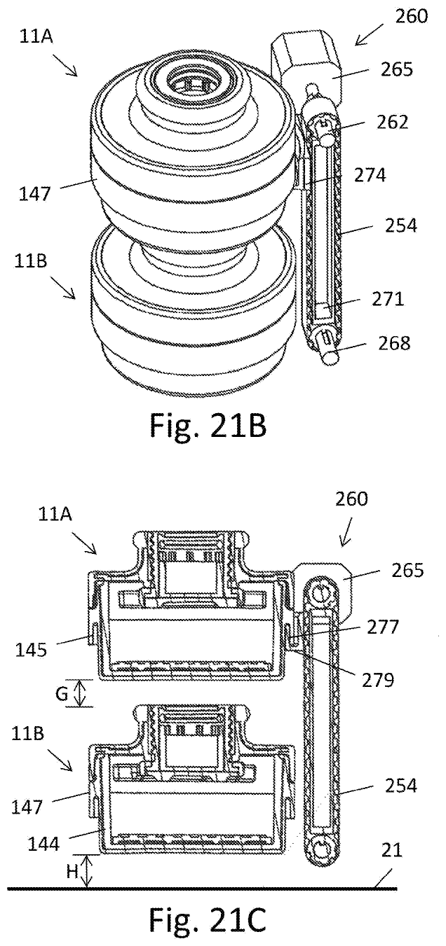

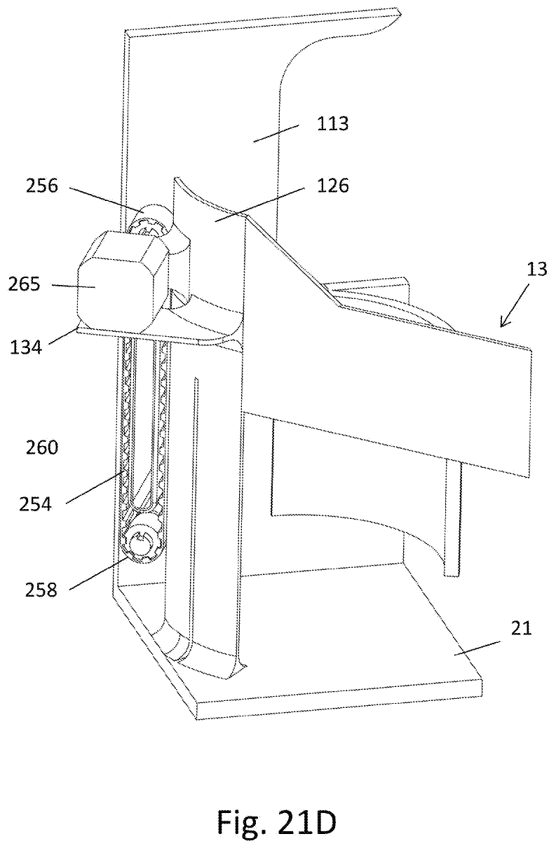

Vertical transfer apparatus 260 illustrated in FIGS. 21A-D is used to selectively vertically displace a clean and unused food vessel 11 that has been introduced into feeding section 13 (FIG. 1A).

Vertical transfer apparatus 260 comprises motor 265 whose stator is attached to a stationary horizontal support platform 134 extending rearwardly from vertical guide element 126 of feeding section 13 that is connected to cooking machine floor 21 and an endless belt 254 passed over a first driving pulley 256 and a second driven pulley 258 having substantially parallel horizontal axes. A shaft extender 262 is coupled with the output shaft 266 of motor 265, such as by a hollow cavity, and is received within the interior of driving pulley 256 to function as a driving shaft. An axial recess 253 is formed within the periphery of shaft extender 262, and is adapted to engage with a tooth 257 radially extending from the inner annular surface 255 of driving pulley 256, in order to transmit rotary motion from the motor output shaft 266 to driving pulley 256. A tubular element 268 configured similarly as shaft extender 252, but of opposite orientation, is received within the interior of driven pulley 258 to function as a driven shaft, and an axial recess 269 formed within its periphery is adapted to engage with the tooth radially extending from the inner annular surface of driven pulley 258. Driven shaft 268 is ratably mounted within casing right wall 113. A stabilizing rectangular frame element 271, for example made of elastomeric material, may be inserted within the interior of endless belt 254.

Two vertically spaced support clips 274, although only one is shown for purposes of clarity, are attached, such as by welding, to the outer surface of endless belt 254. Each support clip 274 is configured with a first wall 272 having a planar surface 273 for attachment to endless belt 254 and a concave surface 276 at the face of first wall 272 which is opposite to planar surface 273, a second wall 277 horizontally spaced from first wall 272 and provided with a concave surface 278 having substantially the same curvature as concave surface 276 of first wall 272 and as the shortened-length outer wall 147 of food vessel 11, and an interconnecting element 279 extending between the bottom of first wall 272 and of second wall 277. Support clip 274 is rendered flexible by virtue of the interspace between first wall 272 and second wall 277. Each of first wall 272 and second wall 277 may be made of a flexible material.

When vertical transfer apparatus 260 is mounted within the cooking machine, endless belt 254 is aligned with the circumferential interspace 96 between the arcuate guide element 126 that extends upwardly from sleeve 83 of feeding section 13 and casing right wall 113 (FIG. 1B), and each support clip 274 protrudes inwardly into the volume of a transfer zone delimited by tubular sleeve 83 and by arcuate guide element 126 along which the introduced food vessel 11 is downwardly transferable. Inlet port 84 has a radial dimension substantially equal to, and slightly larger than, outer walls 147 and 162 of a food vessel.

Endless belt 254 may be a toothed timing belt whose teeth are engaged with matching teeth of driving pulley 256 and driven pulley 258, in order to accurately transfer motion from the output shaft 266 of motor 265 to support clip 274. Alternatively, endless belt 254 may be any other suitable belt such as a V-belt which cooperates with corresponding pulleys.

Support clip 274 is configured to support a clean and unused food vessel 11 that has been introduced into the feeding section. Feeding section 13 (FIG. 1B) is configured in such a way so as to require a user to feed a food vessel into inlet port 84 only when the food vessel is oriented in a specific position, namely when the longitudinal axis of the food vessel is perpendicular to cooking machine floor 21. Since a food vessel 11 is one-way introducible into inlet port 84 and each support clip 274 protrudes inwardly into the transfer zone, an upper support clip is assured of intercepting the introduced food vessel immediately after being introduced into the inlet port.

When the introduced food vessel is intercepted, second wall 277 of support clip 274 is received within the interspace 145 between the extended-length outer wall 144 and the shortened-length outer wall 147 of food vessel 11. Shortened-length outer wall 147 is consequently supported by interconnecting element 279 of support clip 274 and may be contacted by first wall 272. While motor 265 is subsequently operated and endless belt 254 transfers downwardly directed motion to support clip 274, the intercepted food vessel will be displaced downwardly and controllably together with endless belt 254.

Vertical transfer apparatus 260 is suitable for supporting two food vessels 11A and 11B while a gap G exists between the receptacle of the upper food vessel 11A and the throat of the lower food vessel 11B, and a gap H exists between the receptacle of the lower food vessel 11B and cooking machine floor 21. Food vessel 11B is indexed to the lower position while food vessel 11A is received in the upper position.

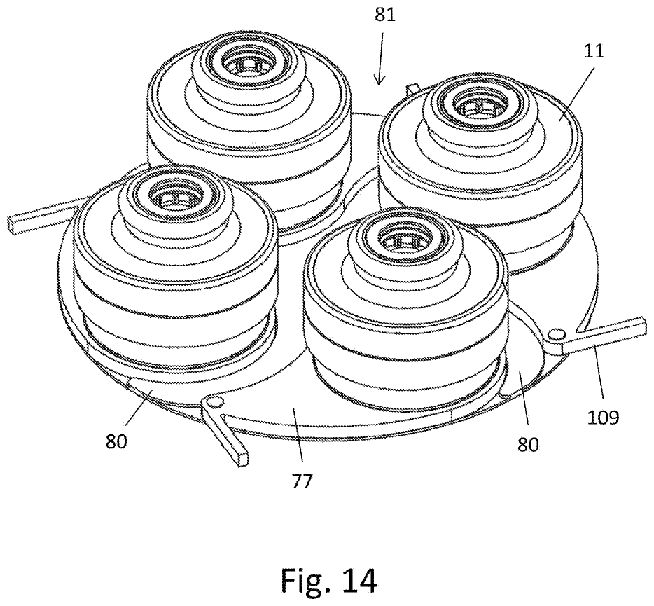

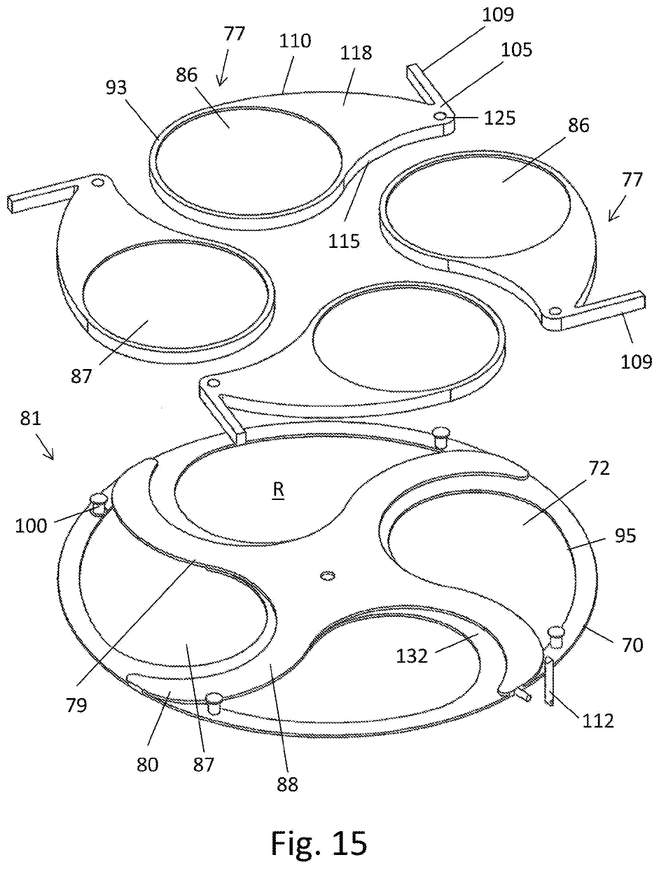

Lower food vessel 11B is held in the illustrated waiting position until carried by holding plate 81 (FIGS. 14-15) and rotated from one station to another, in order to be uncovered, filled with desired food products or liquids, and heated in order to prepare cooked food.

The food products that are received within an open food vessel 11 are heated by the cooking apparatus 22 schematically illustrated in FIG. 1B. Cooking apparatus 22 comprises a plurality of circumferentially spaced induction heating units 82, e.g. four, each of which comprising an induction coil and being mounted below circular holding plate 81 shown in FIGS. 14 and 15 which is rotatable in two rotational directions, and a frequency generator, which interfaces with the controller and is in wireless communication with circuitry of each induction heating unit 82.

As shown in the exploded view of FIG. 15, holding plate 81, which may be made from ceramic or glass materials, or from any other suitable material, is configured with a circular base plate 72, and a plurality, e.g. four, of pivotable leaf elements 77 provided with a solid recessed region 86 suitable for the secure placement thereon of a corresponding food vessel to resist relative movement thereof during rotation of plate 81 about its center by a dedicated motor, pivotal displacement of the leaf element, and also during operation of the drive shaft during a mixing operation. A dividing element 79, which may have four arcuate arms 80 extending from a central huh to the outer periphery 70 of base plate 72, is fixed to base plate 72, and protrudes slightly upwardly therefrom, to limit the pivotal displacement of each leaf element 77. A leaf element 77 is sealable in a recessed portion R defined by base plate 72 and two adjacent arms 80 of dividing element 79.

An annular border element 95 of a limited width and coincident with outer periphery 70 protrudes slightly upwardly from the surface of base plate 72, and a short pin 100 for coupling with a corresponding leaf element 77 protrudes from border element 95 proximate to the terminal end of an arm of dividing element 79.

Alternatively, holding plate 81 may be configured without a base plate, such that a void region exists between each arm 80 of dividing element 79 and annular border element 95. For added rigidity of dividing element 79, an arcuate element 132 underlying each arm 79 may extend from border element 95 to a central region underlying the hub of dividing element 79.

Each leaf element 77 has a circular border 93 surrounding recessed region 86, a curved body element 118, which may be tear-shaped, positioned to the side of recessed region 86, and an elongated pivoting-inducing element 109 that protrudes from body element 118, arranged such that the upper surface of recessed region 86, pivoting-inducing element 109 and of body element 118 are substantially coplanar. A first edge 110 of body element 118 is convex, and extends tangentially from a peripheral region of border 93, at which the diameter of the circular recessed region 86 is substantially parallel to the elongated pivoting-inducing element 109, to the terminal end of body element 118 at the junction 105 with pivoting-inducing element 109. The second edge 115 of body element 118 is concave, and extends to junction 105. A through-hole 125 for receiving a corresponding pin 100 by which the corresponding leaf element 77 is pivotally connected to border element 95 is formed within the junction 105 between the terminal end of edges 110 and 115. An angle between the terminal end of edge 110 and pivoting-inducing element 109 is approximately 45 degrees, and may range from 30-120 degrees.

The pivoting action of a leaf element 77 results from the cooperation of both pivoting-inducing element 109 and a one-way collapsible post 112, which is shown in FIG. 1.8 to extend vertically from cooking machine floor 21 close to front casing face 131.

When plate 81 rotates in a first rotational direction, for example in a clockwise direction, each pivoting-inducing element 109 protruding from the periphery 70 of plate 81 contacts post 112 from the same direction, causing post 112 to yield, for example to be folded. While post 112 is folded, each unpivoted leaf element 77 remains seated in its corresponding recessed portion R, which may be a void region, and is in contact with two adjacent arms 80, as shown in FIG. 14, to facilitate continuous rotation of plate 81 in the first rotational direction.

During rotation of plate 81 in a second rotational direction, for example in a counterclockwise direction, the side of a pivoting-inducing element 109 facing body element 118 forcefully contacts post 112, as shown in FIG. 1A. Post 112, when contacted by pivoting-inducing element 109 following this rotational direction of plate 81, remains rigid. Due to the interaction between pivoting-inducing element 109 and post 112, the corresponding leaf element 77 pivots about the pin 100 with which it is rotatably coupled and is consequently directed towards tubular sleeve 83 (FIG. 18) in order to carry a food vessel held in the waiting position.

A presence sensor 87 may be mounted on base plate 72 at each recessed portion R to detect whether a leaf element 77 has been positioned within a corresponding recessed portion of the base plate and on the recessed region 86 of each leaf element 77 to detect whether a food vessel has been positioned therewithin, and plate 81 may be provided with a location sensor 88 to detect the angular position of the plate. Each presence sensor 87 and location sensor 88 is preferably in wireless communication with controller 2 (FIG. 1D). Alternatively, each presence sensor 87 and location sensor 88 is in electrical communication with controller 2 by a wired connection.

Following detection of a food vessel that is positioned within a specific region 86 and that the leaf element 77 of the specific region has been seated within a corresponding recessed portion R, one of the induction heating units is configured to generate a magnetic flux field that is directed to, and that causes heating of, an inner ferromagnetic layer of the food vessel, generally due to eddy-current losses. The generated magnetic flux field is preferably focused, for example by means of a flux intensifier provided with induction heating unit, to ensure that the inner ferromagnetic layer of the food vessel separated by a close distance, e.g. as close as 2.5 cm, will be suitably heated and that the generated magnetic flux field will not be directed to a neighboring food vessel.

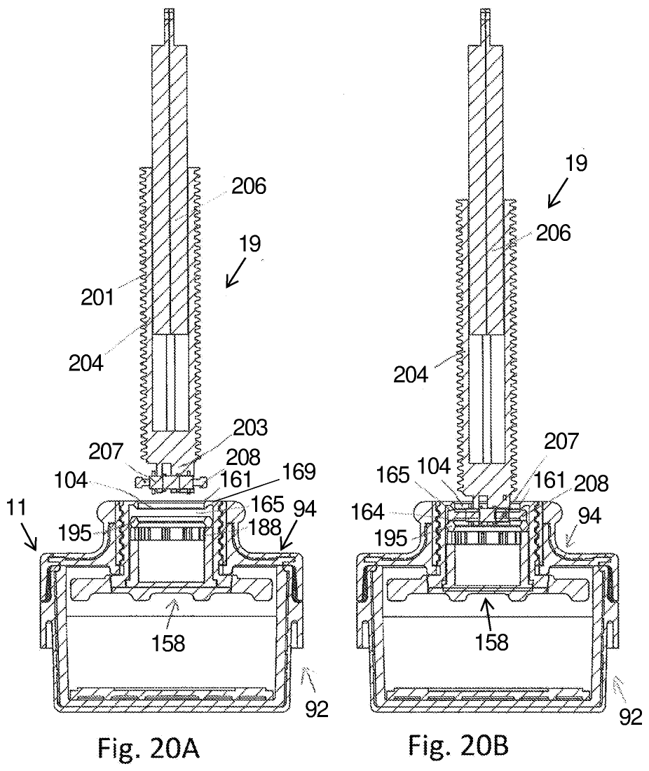

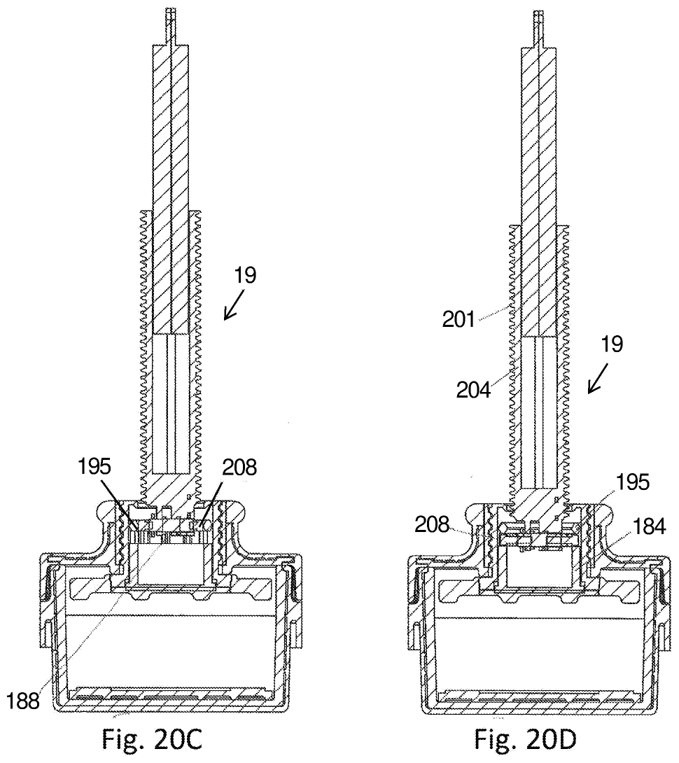

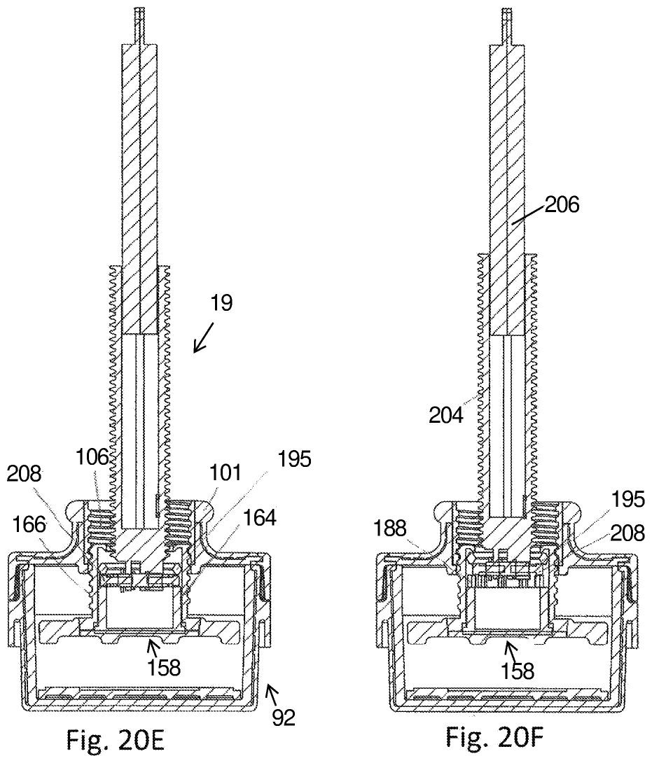

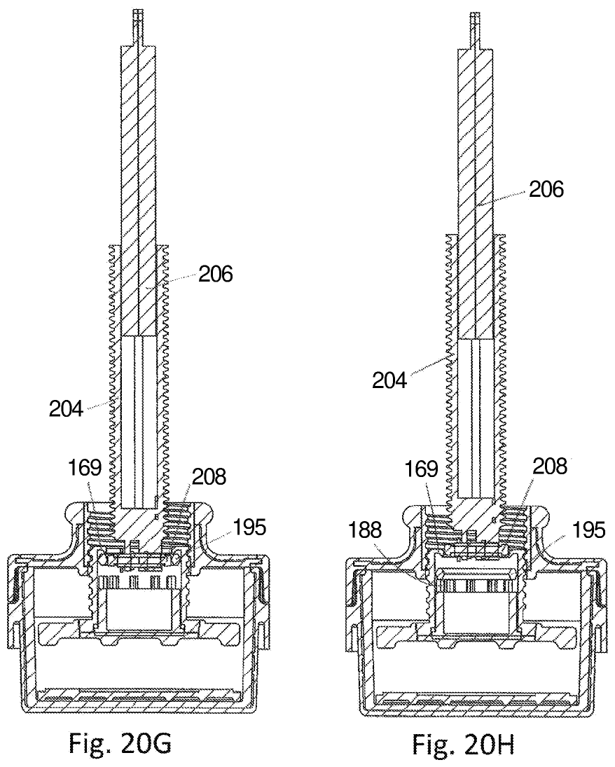

FIGS. 16-19 illustrate the structure of food vessel 11. Food vessel 11 comprises a lower receptacle 92 having an upper opening, and an upper cover member 94 which has an annular lid 102 adapted to freely abut, i.e. without being secured to, a peripheral wall of receptacle 92 and to thereby cover the upper opening. Cover member 94 also has an annular throat 101 projecting upwardly and continuously from lid 102 to define a central socket 104 adapted for interfacing with extendable and rotatable drive shaft 19, as will be described hereinafter with relation to FIGS. 20A-H.

The peripheral wall of receptacle 92 may be three-layered, such that outer layer 144 is made of ceramic material and outermost layer 147 is made of silicone with an intervening air space 145 therebetween, and the innermost layer 141 is made of a food-safe ferromagnetic material. Alternatively, both layers 144 and 147 between which intervening air space 145 is located are made of ceramic material. According to this arrangement, the inner ferromagnetic layer 141 which is impinged upon by the generated magnetic flux field becomes sufficiently heated, e.g. to 200° C., to heat the food products received within receptacle 92, yet the outermost layer 147 is advantageously able to became sufficiently cooled in a short period of time, when food vessel 11 is out of range of the magnetic flux field, so that it may be held by a user wishing to remove the food vessel from the cooking machine and then consume the cooked food while continuing to be retained within receptacle 92. Tests conducted by the Applicant revealed that the ceramic layers 144 and 147 have sufficiently high permeability to allow the received food products to become cooked by means of the generated magnetic flux field. For example, the outermost ceramic layer 147, when used, is able to be cooled from 200° C. to 50° C. in 0.5-1 minute.

Additional insulation may be provided to the peripheral wall by vertically spaced apertures 153 formed within the side of wall 144 facing inner ferromagnetic wall 141. Each aperture 153 may extend peripherally throughout wall 144.

The bottom surface 157 of receptacle 92 may be made of the two layers 141 and 144 that are each integrally formed with the corresponding peripheral wall, such that the integral ferromagnetic material section is inserted within, and coupled to, the integral ceramic material section. Portions of the two layers 141 and 144 may be adhesively attached to each other.

Even though lid 102 freely abuts the peripheral wall of receptacle 92 from above, cover member 94 remains in abutment with the receptacle despite lateral movement of the food vessel 11 while being transferred by virtue of the radially recessed peripheral wall of receptacle 92. In the radially recessed configuration, wall 144 vertically extends the entire height of receptacle 92 while outermost wall 147 extends to a height corresponding to the height of only an intermediate region of wall 144. An annular support surface 151 for supporting the peripheral wall 162 of cover member 94 extends horizontally from the top of outermost wall 147 to wall 144, allowing the outer surface of walls 144 and 147 to be radially aligned when receptacle 92 is covered by cover member 94. Accordingly, radial or horizontal movement of cover member 94 relative to receptacle 92 is limited by the portion of wall 141 above support surface 151. The length of outermost wall 147 below support surface 151 may be only a fraction of that of wall 144.

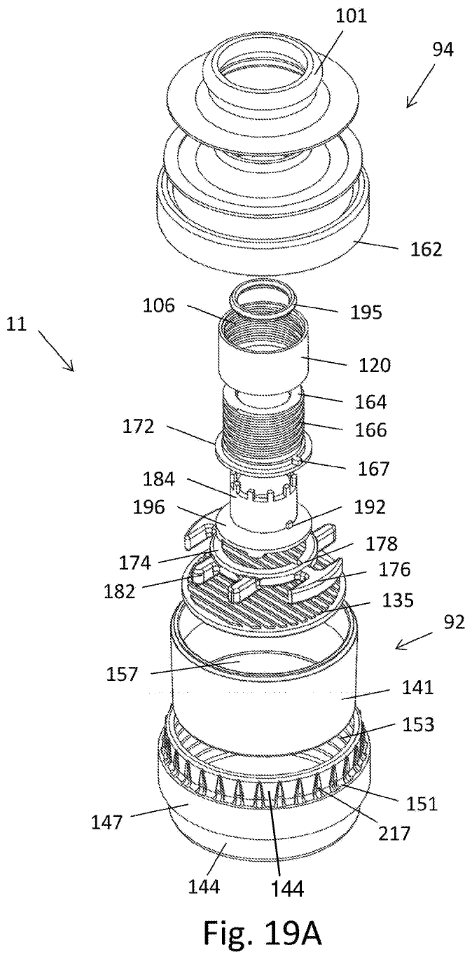

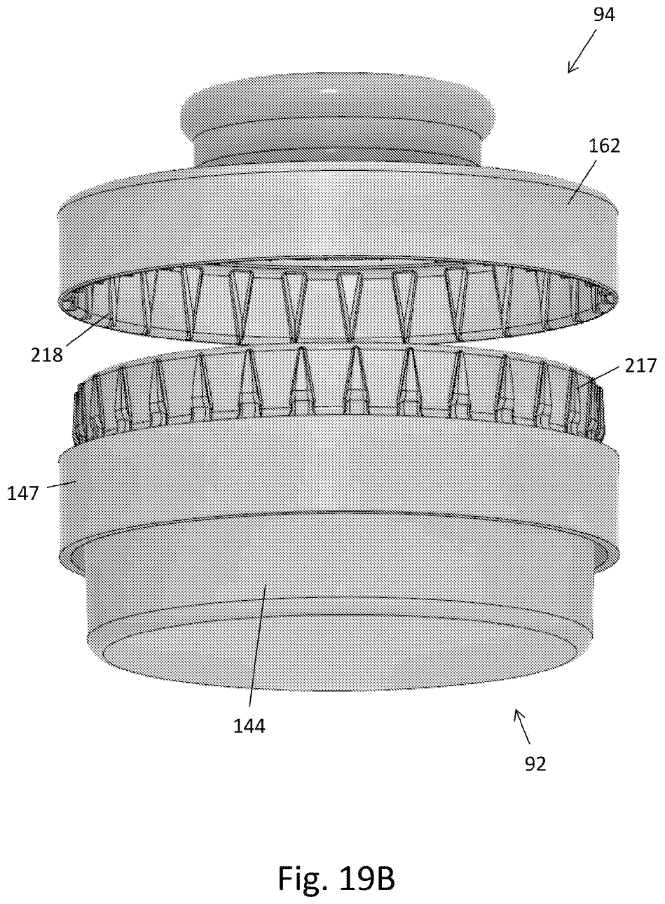

Receptacle 92 and cover member 94 may be configured with means for preventing rotation of one relative to the other, for example during operation of the drive shaft. For example, as shown in FIGS. 19A-8, circumferentially spaced triangular elements 217 protrude outwardly from the portion of wall 144 located above outermost wall 147 of receptacle 92. The base of each triangular element 217 adjoins support surface 151 and the upper vertex thereof adjoins the upper edge of receptacle 92. Also, circumferentially spaced triangular elements 218 protrude inwardly from the inner face of peripheral wall 162 of cover member 94, such that the base of each triangular element 218 adjoins the upper edge of peripheral wall 162 and the lower vertex thereof adjoins the lower edge of peripheral wall 162. When cover member 94 is lowered onto receptacle 92, each triangular element 218 of cover member 94 is received within the interspace between two adjacent triangular elements 217 of receptacle 92 while being in abutment with wall 144. If cover member 94, for example, is caused to rotate, each of the triangular elements 218 will contact one of the triangular elements 217, and the rotational movement will be impeded or completely stopped.

The bottom edge 155 of outermost wall 147 may be located at a height corresponding to a first intermediate region of wall 144, and extends upwardly to annular support surface 151 at a height which corresponds to a second intermediate region of wall 144. As will be described, the shortened-length outermost wall 147 facilitates supporting food vessel 11 automatically within the interspace 145 between walls 144 and 147.

The bottom surface 157 of receptacle 92 may be configured with a plurality of elongated grate protrusions 97 for grilling a protein-rich food product such as a hamburger. The grate protrusions 97 may protrude upwardly directly from bottom surface 157, or alternatively may be formed in a separate unit 135 supported by bottom surface 157. Unit 135 may be attached to, or integrally formed with, bottom surface 157.

A drive shaft interface member 158 may be engaged with cover member 94. To engage interface member 158 with cover member 94, throat 101 of cover member 94 may be formed with internal threading 106 which is threadedly engageable with external threading 166 formed on the tubular peripheral wall 164 of interface member 158. Internal threading 105 may be formed on a tube 120 which is attached to an inner wall of throat 101.

Peripheral wall 164 of interface member 158, which is provided with an annular abutment 169 delimiting socket 104 at its upper end and with an annular protrusion 172 at its lower end, is engaged with an annular implement-holding unit 174, for example by means of a key 167 and groove 178. A radial interspace 163 may be defined between peripheral wall 164 and the radially outward edge 168 of abutment 169, which may be oblique with respect to peripheral wall 164. The radially inward edge 161 of abutment 169, although not shown, is generally sloped downwardly in a direction towards the longitudinal axis of throat 101. One or more rigid implements 176 may radially extend from the annular unit 174. When the drive shaft is inserted within socket 104 and coupled with interface member 158 and is rotated, each implement 176 is rotated as well, allowing food products introduced within receptacle 92 to be mixed, particularly together with added liquids.

Alternatively, peripheral wall 164 is integrally formed with implement-holding unit 174.

An implement 176 may be a wide-area implement, for example constituted by a plurality of interconnected but spaced grilling elements 182 that may be coplanar. When the drive shaft is downwardly displaced and caused to rotate, both interface member 158 and implement 176 are lowered as well, to facilitate performance of a grilling action with respect to both sides of the protein-rich food product that has been introduced within receptacle 92. Interface member 158 may be simultaneously vertically and rotatably displaced.

To prevent damage to lid 102 of cover member 94 by contact with a heated implement 176 upon the conclusion of a grilling action and the raising of interface member 158, the underside 107 of lid 102 is planar and a protrusion 98 downwardly protruding from underside 107 may be provided directly below internal threading 106 of throat 101. The radial inward disposition of protrusion 98 is aligned with internal threading 106, or is slightly outwardly radially spaced from internal threading 106 to prevent interference with interface member 158 when undergoing vertical displacement.

FIG. 17 illustrates interface member 158 at a lowered position relative to throat 101, and FIG. 18 illustrates interface member 158 at a raised position. When interface member 158 is at a raised position, annular protrusion 172 of interface member 158 abuts protrusion 98 at the lid underside to ensure an interspace between a heated implement 176 and lid underside 107.

Interface member 158 also comprises a toothed adapter tube 184 that is in close proximity to peripheral wall 164, for example in abutting relation or integrally formed therewith. The upper edge 186 of adapter tube 184 from which upwardly extend a plurality of circumferentially spaced teeth 188 is located below annular abutment 169, coinciding with an intermediate region of peripheral wall 164, such as at a halfway region of peripheral wall 164. Adapter tube 184 may be engaged with protrusion 172 of peripheral wall 164, for example by means of a key 192 and corresponding groove. A circular plate 196 provided with small legs may be provided below adapter tube 184.

A ring 195 used for initiating decoupling of the drive shaft from interface member 158 may be loosely fitted between abutment 169 and teeth 188.

It will be appreciated that cover member 94 may be configured without interface member 158, as long as it is provided with an upper annular abutment 169.

FIGS. 20A-H illustrate drive shaft 19 at different positions, including when positioned in a raised position overlying socket 104 of cover member 94, and when positioned in a lowered position after having been coupled with interface member 158.

As shown in FIG. 20A, drive shaft 19 has an outer rotatable section 204 provided with a plurality of vertically spaced protrusions 201, each of which is engageable with a rotatable drive element such as a gear that facilitates vertical displacement of the drive shaft as well as positional stability at any given height. Outer section 204 is bored, and an inner tubular section 206 driven by a motor is movably connected to outer section 204. A horizontal holder 207 for a spring-loaded latch 208 is connected to a bottom portion 203 of outer section 204. Latch 208 may comprise two linearly and independently extendable spring-loaded rods that are housed in holder 207.

At the starting position of FIG. 20A, holder 207 overlies socket 104 of the cover member 94 which covers the receptacle 92 of the food vessel 11 being instantaneously positioned below drive shaft 19. Each of the two latches 208 at the illustrated spring-biased extended position extends radially outwardly relative to inner edge 161 of the upper abutment 169 of interface member 158, as well as from the downwardly sloping inner edge of ring 195. An interspace 165 is defined between abutment 169 and ring 195, which is loosely supported from below by the circumferentially spaced teeth 188.

At the next position of FIG. 20B, outer section 204 of drive shaft 19 is lowered relative to inner section 206 thereof; causing holder 207 to be introduced into socket 104. While the two spring-loaded latches 208 are being lowered, they contact the sloped radially inward abutment edge 161 and are urged to contract radially inwardly, until clearing abutment edge 161 and being received within interspace 165 located above ring 195. Within interspace 165, the latches 208 cease to be contacted by abutment edge 161 and extend until they are restrained by peripheral wall 164 of interface member 158.

At this position, the loosely supported cover member 94 is engaged by latches 208. Once the entire drive shaft 19 is raised, cover member 94 together with interface member 158 are raised as well, and receptacle 92 becomes uncovered.

If the entire drive shaft 19 is lowered rather than being raised as shown in FIG. 20C, latches 208 contact the sloped ring 195 and are urged to contract radially inwardly. While drive shaft 19 continues to be lowered, it clears ring 195 until the downward movement of the two latches 208, which are once again extended, is limited by adapter tube 184, as shown in FIG. 20D.

At the position of FIG. 20D, each of the two extended latches 208 is introduced between two adjacent teeth 188 of adapter tube 184 shown in FIGS. 18 and 20C. The width of each latch 208 is substantially equal to the spacing between adjacent teeth 188, to ensure secure frictional engagement therewith and to transmit torque without substantial circumferential play, if any.

Thus when drive shaft 19 is rotated, as shown in FIG. 20E, the torque of the drive shaft is transmitted to the teeth, and then to the peripheral wall 164 of interface member 158. This rotary motion causes external threading 165 of peripheral wall 164 to rotate in a first rotational direction with respect to internal threading 106 of cover member throat 101 and interface member 158 to be lowered with respect to throat 101. When interface member 158 is being rotated, food items located within receptacle 92 are able to be mixed. When interface member 158 is located close to a lowermost position, a protein-rich food product such as a hamburger is able to be grilled on both of its sides.

While interface member 158 is being lowered or drive shaft outer section 204 is being subsequently raised relative to inner section 206, as shown in FIG. 20F, whereby the two latches 208 are released from teeth 188, the extended latches are located beneath ring 195.

At the next stage shown in FIG. 20G, drive shaft outer section 204 is additionally raised relative to inner section 206. Latches 208 are compressed upon contacting ring 195, and are urged to be introduced within the interior of the ring. Ring 195 is thus in secured contact from below with cover member abutment 169.

At the next stage shown in FIG. 20H, drive shaft outer section 204 is additionally raised relative to inner section 206, such that latches 208 become released from ring 195 while the latter is in secured contact with abutment 169. The latches are subsequently raised and additionally compressed until they contact abutment 169. After latches 208 are released from ring 195, the ring falls to its starting position whereat it supported from below by teeth 188.

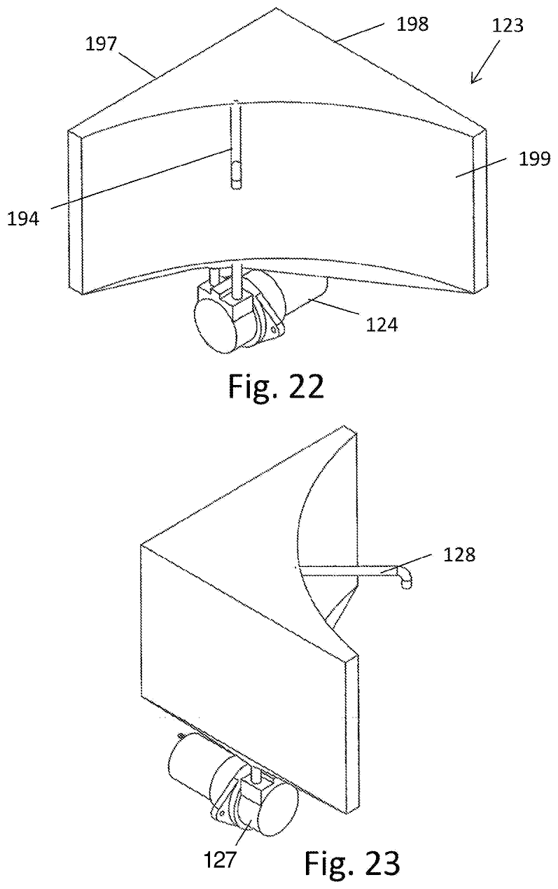

An oil reservoir 123, e.g. having a volume of one liter, from which oil is able to be controllably discharged in order to be introduced to a food vessel is illustrated in FIG. 22. Oil reservoir 123 may be configured with two perpendicular walls 197 and 198 and with a concave inner wall 199 circumferentially extending between the two perpendicular walls 197 and 198 in order to be compactly positioned in abutting relation with an inner corner of the casing at the third level of the cooking machine without interference with the rotatable circular plates 25 and 81, for example as shown in FIGS. 10 and 1F. A peristaltic pump 124, which may be mounted to the bottom of oil reservoir 123, may be used to cause controlled discharge of oil through a dedicated groove 194 formed in inner wall 199.

A control valve 127 shown in FIG. 23 may be used to supply a controlled volume of water to a food vessel via tube 128. A heating element downstream to control valve 127 may be employed in order to supply hot or boiling water, for example to prepare soup.

### Control System

FIG. 24 schematically illustrates control system 140. Control system 140 comprises a plurality of conveyor motors 51 each of which adapted to cause conveyance of a different type of unperishable food to the discharging section so that is will be discharged to an open food vessel, a plurality of food dispenser motors 68 each of which adapted to cause a different frozen food to be dispensed to another open food vessel, motor 142 for causing rotation of the food vessel holding plate, motor 143 for causing rotation of the insulating plate, motor 146 for causing operation of the drive shaft, and vertical transfer motor 265. Controller 2 is in electrical communication with each of these motors, and commands when they are to be operated.

Controller 2 is also in electrical communication with a plurality of presence sensors 87 provided with the food vessel holding plate for detecting whether a food vessel has been positioned within a corresponding region, at least one location sensor 88 to detect the angular position of the food vessel holding plate, at least one location sensor 89 to detect the angular position of the insulating plate, a presence sensor 91 located within each food dispenser, a presence sensor 108 located within each compartment of the food storage section, peristaltic pump 124 for discharging a controlled volume of oil, control valve 127 for discharging a controlled volume of water, and heating element 129 for heating the discharged water to a desired temperature. Each of presence sensors 87, 91 and 108 may be a weight sensor, such as a load cell.

A user interface 152 is in data communication with controller 2, and is used to select the desired food products to be cooked as well as the desired time and day when the food products are desired to be eaten. User interface 152 may be a touchscreen configured with dedicated input elements which is accessibly housed in a door of the cooking machine. A user may manipulate these input elements, such as with an authorized code, for selection of the desired food products to be cooked and of the desired cooking time. Alternatively, user interface 152, which may be a graphical user interface (GUI), is accessible by a dedicated application running on a computerized device of the user, such as a smartphone, to support remote selection of the desired food products to be cooked and of the desired cooking time. Communication equipment 154 enables the computerized device to communicate with user interface 152. User interface 152 may indicate when the desired food products are sufficiently cooked and are ready to be eaten. An enunciator 156 connected to user interface 152 may notify when the desired food products are ready to be eaten.

A safety door interlock unit 159 in communication with controller 2 prevents a door through which food vessels or food products are introduced into the interior of the cooking machine from being opened when one or more of the induction heating units 82, motors 51, 68, 142443, 146, and 265, peristaltic pump 124, control valve 127, and heating element 129 is operated.

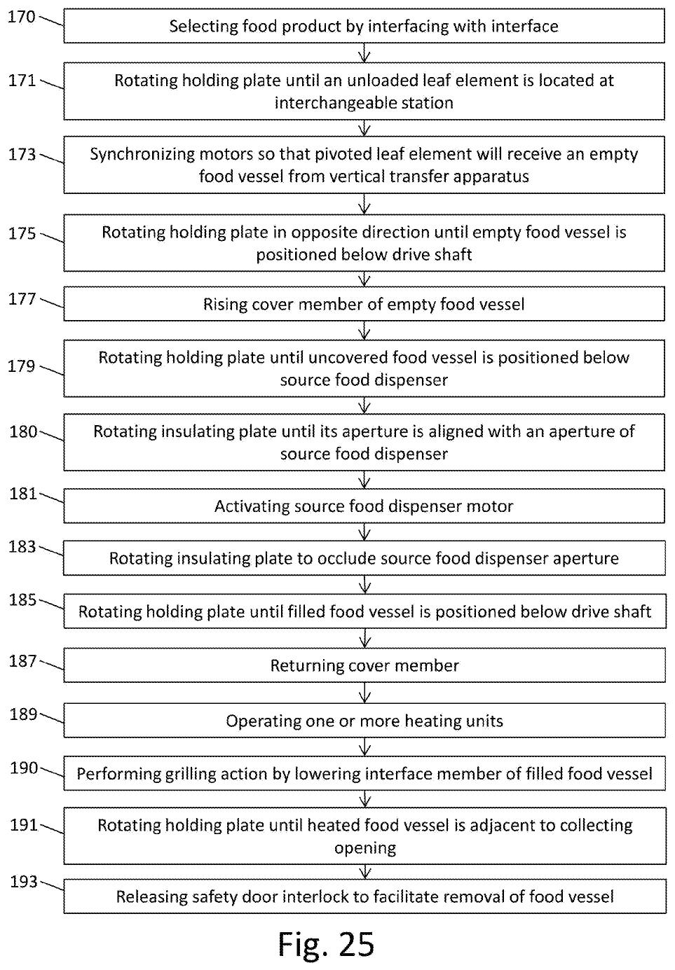

FIG. 25 illustrates a flow chart illustrating various control system operations involved in cooking and serving personalized food portions when the cooking machine is sufficiently loaded with food items and with food vessels. It will be appreciated that many more operations may be performed, depending on user selection, both respect to a single food vessel or to a plurality of food vessels.

In step 170, the food products to be cooked and served are selected through interaction with the user interface. The controller verifies in step 171 by means of a presence sensor that a pivoted leaf element located at a station of the holding plate which is about to rotatably approach the vertical transfer apparatus (hereinafter the “interactable station”) is unloaded, i.e. devoid of a food vessel, and if not, the holding plate is rotated until an unloaded leaf element is located at the interactable station. The vertical transfer motor and holding plate motor are then commanded in step 173 to synchronize their operation such that the support clip becomes detached from the food vessel located at the lower, waiting position simultaneously with the introduction of the pivoted leaf element at the interactable station into the transfer zone delimited by the tubular sleeve. The vertical transfer motor is commanded to continue its operation after the pivoted leaf element receives an empty food vessel from the waiting position, causing the support clip to be displaced along the endless belt and to therefore become detached from the empty food vessel. While the vertical transfer motor continues its operation, the detached support clip passes around the driven pulley, after being flexed so as to assume a vertical dimension less than gap H (FIG. 21C), and is displaced towards the driving pulley in order to participate in another intercepting operation.

In step 175, the holding plate is rotated in an opposite rotational direction while the leaf elements are unpivoted until the empty food vessel is located at a station below the drive shaft. The drive shaft is then operated in step 177 to raise the cover member of the empty food vessel. Afterwards, the holding plate is rotated in step 179 until the empty food vessel is located at a station below a food dispenser containing the selected perishable food product (hereinafter the “source food dispenser”). The insulating plate is then rotated in step 180 until the aperture of the insulating plate is aligned with an aperture associated with the source food dispenser, after which the source food dispenser motor is activated in step 181 to cause the selected perishable food product to be gravitationally dispensed into the uncovered food vessel. The insulating plate is rotated once again in step 183 to occlude the aperture associated with the source food dispenser.

To ensure that the dispensed perishable food product is suitably cooked, the holding plate is rotated once again in step 185 until the filled food vessel is located below the drive shaft, and then the drive shaft is operated in step 187 so that the cover member will be returned to cover the uncovered food vessel. One or more induction heating units are operated in step 189 in accordance with a predetermined sequence, and simultaneously or sequentially the drive shaft is operated in step 190 to cause the interface member of the heated food vessel to be lowered so that a grilling action will be performed with respect to the dispensed perishable food product by one or more grilling elements associated with the interface member. After the one or more grilling elements are raised upon completion of the grilling action, the holding plate is rotated in step 191 so that the heated food vessel will be positioned at the station that is accessible to the collection opening. The safety door interlock operatively connected to the collection opening is released in step 193, so that the user will be able to safely receive the food vessel containing the one or more cooked food items.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. An automatic home cooking machine, comprising:
a) a food storage section for dry and unperishable food products;
b) means for controllably discharging food products from said food storage section;
c) a dispensing section which includes a plurality of spaced controllable food dispensers retained within a stationary freezer compartment;
d) a lower plate on which are positionable a plurality of food vessels;
e) at least one induction heating unit configured to generate a magnetic flux field that is directed to at least one of the food vessels;
f) a rotatable insulating plate located below said freezer compartment and formed with an aperture through which desired food products are gravitationally delivered either from said food storage section or from said dispensing section to an underlying one of the food vessels located directly below said aperture; and
g) cooking apparatus adapted to cook the food products received within each of the food vessels.

2. The cooking machine according to claim 1, further comprising an outer casing which is adapted to accommodate an above-counter or built-in space.

3. The cooking machine according to claim 1, wherein each of the plurality of food dispensers is configured with a bottomless storage section within which one or more perishable food products are storable, a rigid lid positioned on top of said storage section, and a rotatably mounted shaft connected to a center of the lid which, when rotated, causes the lid to rotate and the one or more perishable food products to gravitate from said storage section.

4. The cooking machine according to claim 3, wherein the freezer compartment is configured with a bottom wall that is formed with a plurality of apertures within each of which the storage section of a corresponding food dispenser is frictionally fitted.

5. The cooking machine according to claim 4, wherein the food storage section is configured with a plurality of separate and elongated compartments within each of which a different unperishable food product is storable, and the means for controllably discharging food products from the food storage section comprises a screw conveyor rotatably mounted in each of said plurality of compartments to facilitate conveyance and discharge of a predetermined amount of a selected food product, a trough for receiving the discharged unperishable food product, and a chute extending downwardly and at an incline from the trough.

6. The cooking machine according to claim 5, wherein side walls of the freezer compartment are configured with an undercut arrangement to ensure that the rotatable insulating plate will be in insulating proximity to the bottom wall of the freezer compartment and that a portion of the insulating plate will be positioned externally to the freezer compartment, so as to be accessible to an exit opening of the chute.

7. The cooking machine according to claim 6, further comprising a controller which is operable to—
i. rotate the insulating plate to a first position, prior to rotation of the shaft to cause gravitational dispensing of the one or more perishable food products from a selected food dispenser to the underlying food vessel, such that the aperture of the insulating plate is aligned with the aperture of the freezer compartment with which the selected food dispenser is frictionally fitted and other apertures of the freezer compartment are occluded by the insulating plate; and
ii. rotate the insulating plate to a second position, prior to operation of one of the screw conveyors to cause gravitational delivery of a selected unperishable food product via the chute to the underlying food vessel, such that the aperture of the insulating plate is aligned with the exit opening of the chute while the other apertures of the freezer compartment are occluded by the insulating plate.

8. The cooking machine according to claim 1, further comprising a feeding section laterally spaced to the freezer compartment through which an used food vessel is introducible, and vertical transfer apparatus configured with a vertically oriented endless belt aligned with an interspace between said feeding section and a cooking machine casing and with one or more support clips attached to said endless belt for intercepting a food vessel introduced through said feeding section, wherein said vertical transfer apparatus is adapted to downwardly transfer said intercepted food vessel to a waiting position above a cooking machine floor.

9. The cooking machine according to claim 8, wherein the lower plate is configured with a circular base plate, a plurality of pivotable leaf elements each of which provided with a solid recessed region to support a corresponding food vessel, and a dividing element, wherein of each said leaf elements is outwardly pivotable with respect to said base plate during rotation in a first rotational direction of the lower plate and is seatable in a corresponding recessed portion defined by said base plate and two adjacent arms of said dividing element when set to a non-pivoted position during rotation in a second rotational direction of the lower plate which is opposite to the first rotational direction.

10. The cooking machine according to claim 9, wherein rotation of the lower plate is synchronized with operation of the vertical transfer apparatus, such that one of the leaf elements is pivoted into a zone of the feeding section to receive the food vessel held at the waiting position during release of the support clip from the food vessel held at the waiting position.

11. The cooking machine according to claim 1, wherein the food vessel is adapted for facilitating both cooking of food products received therewithin and holding the food products after being cooked and while being eaten, wherein said food vessel comprising a lower receptacle having an upper opening, and an upper cover member covering the upper opening, wherein an outer layer of the receptacle is made of ceramic material and an inner layer thereof is made of a food-safe ferromagnetic material that becomes sufficiently heated to cook the received food products when impinged upon by a magnetic flux field generated by the at least one induction heating unit, and wherein the outer ceramic layer is able to become sufficiently cooled within less than one minute, when the food vessel is out of range of the magnetic flux field, so that the food vessel is able to be safely held by a user wishing to eat the cooked food products while continuing to be retained within the receptacle.

12. The food receptacle according to claim 11, wherein a peripheral wall of the receptacle is three-layered, such that at least one of two outer layers of the receptacle which are disposed outwardly from the inner ferromagnetic material layer is made of the ceramic material and an intervening air space layer is disposed between the two outer layers.

13. The food receptacle according to claim 11, wherein the cover member is loosely receivable on top of the receptacle, and has an upwardly projecting annular throat which is provided with an inwardly disposed annular abutment that defines a central socket adapted to receive and interface with an extendable and rotatable drive shaft configured with two spring-loaded latches.

14. The food receptacle according to claim 13, wherein the abutment is configured to urge radially inward compression of the two latches during downward displacement of the drive shaft that causes contact with the abutment, and to provide secured engagement with the two latches after being extended following additional downward displacement of the drive shaft, and wherein the cover member is removable from the receptacle following upward displacement of the drive shaft while the two latches are in secured engagement with the abutment.

15. The food receptacle according to claim 13, wherein the cover member is further comprised with an interface member configured with the abutment and with a cooking worthy implement, the interface member being vertically and rotatably displaceable with respect to the throat during selective manipulation of the drive shaft.
